(19) United States
(12) Patent Application Publication
(10) Pub. No.: US 2026/0333049 A1
(43) Pub. Date: Oct. 22, 2026

(54) SYSTEM AND METHOD FOR MALWARE CONTAINMENT VIA FIREWALL PLACEMENT IN LARGE SCALE WIRELESS IOT NETWORKS

(71) Applicant: KING FAHD UNIVERSITY OF PETROLEUM AND MINERALS, Dhahran (SA)

(72) Inventor: Wessam Ali MESBAH, Dhahran (SA)

(73) Assignee: KING FAHD UNIVERSITY OF PETROLEUM AND MINERALS, Dhahran (SA)

(21) Appl. No.: 19/180,236

(22) Filed: Apr. 16, 2025

(51) Int. Cl. H04W 12/088; H04W 12/128

(52) U.S. Cl. CPC H04W 12/088; H04W 12/128

(57) ABSTRACT

A system and method direct to placing firewalls in an Internet of Things (IoT) network. The IoT network includes wireless IoT devices configured to communicate in an ad-hoc manner using direct Device-to-Device communication links. The system comprises an interactive display screen configured to arrange a graphical representation of the wireless devices based on initial relative locations. The system further includes processing circuitry configured to minimize the number of firewalls required to divide the IoT network into clusters of maximum size by executing a three-stage process. The process includes a first stage of two-way exchange between neighboring clusters, a second stage of one-way exchange of vertices between clusters based on vertex weights and gain, and a third stage of choosing IoT devices to activate their firewalls. Each firewall is configured to protect wireless IoT devices within its communication range from receiving malware. The display screen outputs indications for the chosen firewall locations.

### STATEMENT REGARDING PRIOR DISCLOSURE BY THE INVENTORS

Aspects of this technology are described in an article Wessam Mesbah. Malware Containment via Firewall Placement in Large Scale Wireless IoT Networks. TechRxiv. Sep. 23, 2024, and is herein incorporated by reference in its entirety.

### STATEMENT OF ACKNOWLEDGEMENT

The support provided by the Deanship of Graduate Studies at King Fahd University of Petroleum & Minerals (KFUPM), Dhahran, Saudi Arabia, is gratefully acknowledged.

### BACKGROUND

### Technical Field

The present disclosure is directed to a system and method for malware containment through spatial firewall placement in large-scale wireless Internet of Things (IoT) networks. The system and method are from a perspective of two problems. The objective of the first problem is to reduce the number of firewalls required to divide the network into a given number of isolated clusters. The second problem aims at maximizing the number of isolated network clusters that can be achieved given an available number of firewalls.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

A wireless Internet of Things (IoT) network refers to a decentralized system comprising interconnected wireless IoT devices that communicate with one another over short-range or long-range wireless communication protocols without relying on fixed infrastructure. The scale of a wireless IoT network can be large for a given communication region. IoT networks are increasingly deployed in various mission-driven domains, including intelligent transportation systems, power distribution grids, autonomous vehicular systems, and smart industrial infrastructure. These mission-driven domains can have a high density of IoT devices in the given communication region.

Each IoT device in an IoT network typically includes sensing, actuation, processing, and communication capabilities, and is configured to operate autonomously or cooperatively within the network. IoT devices in the IoT network are typically characterized by low power consumption, constrained memory capacity, and limited computational capability.

The IoT devices are configured to communicate wirelessly in a decentralized and ad-hoc manner, forming dynamic and infrastructure-less topologies. Communication among devices is often realized through direct Device-to-Device (D2D) communication links, allowing data to be relayed in multihop manner without reliance on centralized routing infrastructure.

The various mission-driven domains, including intelligent transportation systems, power distribution grids, autonomous vehicular systems, and smart industrial infrastructure rely on the high connectivity afforded by D2D wireless links to support remote control, environmental sensing, and information dissemination. However, the pervasive interconnectivity and lack of centralized oversight expose the IoT network to advanced cybersecurity threats, including malware propagation.

Malware in the wireless IoT network can propagate from one node to another through the wireless communication links, particularly in the absence of security barriers such as firewalls. Once introduced into the network, malware can exploit software vulnerabilities and limited device security to self-replicate and compromise additional devices in range. The risk of large-scale malware or botnet epidemics is accentuated by the use of reprogramming protocols such as Trickle, Firecracker, and Deluge, which facilitate wireless firmware distribution and inherently possess epidemic characteristics.

Adversaries may initiate malware propagation either through physical access to a network node or via wireless injection mechanisms, including airborne agents such as drones. Upon initial infection, the compromised devices may form a distributed botnet, which is a collection of malware-infected devices controlled remotely by an adversary (botmaster). Botnets may be utilized to launch various forms of network attacks, including Wireless Denial of Service (WDOS) attacks, wherein the adversary attempts to flood the network with malicious traffic, thereby disrupting legitimate communication.

A conventional malware attack is typically structured in two sequential stages. First, initial spread and replication across as many devices as possible, and second, a coordinated global disruption. The malware exploits D2D links to propagate from one device to another, amplifying infection in a chain-reaction manner.

Several preventive measures have been proposed to mitigate malware spread in IoT networks. One approach involves periodic and blind patching of all network devices, as referenced in earlier studies. In this method, patching operations are executed uniformly across the network without prior identification of infected nodes. This technique incurs substantial operational costs, as it necessitates halting normal device functionality and may disrupt devices that are not compromised.

An alternative strategy involves the deployment of spatial firewalls, either as hardware units equipped with anti-malware and intrusion detection software or as software modules installed on existing IoT devices. A spatial firewall monitors its wireless vicinity for anomalous behavior indicative of malware activity and triggers localized countermeasures upon detection. This approach enables targeted intervention, thereby reducing unnecessary patching and preserving overall network efficiency.

Deployment of spatial firewalls in a large-scale IoT network is, however, constrained by economic and practical considerations. The cost of installing and maintaining firewalls across all devices renders universal deployment infeasible. As such, selective deployment strategies have been studied. For instance, prior work has explored methods for immunizing a subset of nodes using a limited number of available firewalls. In one approach, firewalls are assigned to nodes with the highest degree of connectivity in descending order, with re-evaluation after each placement to maximize coverage.

Earlier literature has also addressed related optimization problems such as minimizing the distance between unprotected nodes and centralized authentication entities. However, a more nuanced objective is to prevent malware percolation by partitioning the network into isolated clusters, where each cluster is secured at its boundary using spatial firewalls. Still improper placement of firewalls may permit malware to spread across clusters prior to detection, potentially requiring widespread patching and leading to systemic network failure.

Accordingly, two primary optimization problems can arise depending on whether a network is limited to a fixed number of firewalls, or an objective can be to minimize the number of firewalls in a network. A first optimization problem seeks to minimize the number of firewalls required to divide the network into a predetermined number of isolated clusters, each subject to a constraint on maximum cluster size. A second optimization problems seeks to maximize the number of isolated clusters that can be achieved using a fixed number of firewalls, while adhering to similar size constraints. Both problems are combinatorially intractable and belong to the class of NP-hard problems. Efficient algorithmic solutions are thus required to achieve computationally feasible performance.

To fulfil these objectives, recent approaches have presented multi-stage clustering algorithms that reduce inter-cluster connectivity and determine optimal firewall placements. Comparative studies demonstrate that these methods consistently outperform conventional clustering algorithms, such as K-Means, in terms of effectiveness in malware containment and minimization of firewall usage.

Spatial firewalls may be classified into two types based on their functional scope. A first type is a self-protecting firewall, which provides protection solely to the device on which it is installed. A second type is a coverage-based firewall, configured to protect all devices within its wireless communication radius. In the second type, devices situated within the firewall's communication range are configured to consult the firewall before executing received software payloads. The operational paradigm of each firewall type influences the network's overall defense structure and dictates the design of the placement algorithm.

Accordingly, one object of the present disclosure is to provide a method and system capable of dynamically placing a limited number of spatial firewalls across a wireless IoT network to partition the network into secure clusters, thereby containing the spread of malware and minimizing the associated patching overhead. A further object is a method and system capable of dynamically reducing the number of firewalls required to divide the network into a given number of isolated clusters.

### SUMMARY

In an exemplary embodiment, a system for positioning firewalls in an Internet of Things (IoT) network is described, wherein the IoT network includes a plurality of wireless IoT devices that communicate in an ad-hoc manner using direct Device-to-Device (D2D) communication links. The system includes an interactive display screen configured to arrange a graphical representation of the wireless devices based on initial relative locations. The system further includes processing circuitry configured to minimize a number of firewalls required to divide the IoT network to a number of clusters of maximum size by executing a first stage of two-way exchange between every two neighboring clusters of the number of clusters of maximum sizes, including examining the two-way exchange of every two vertices in the two neighboring clusters, and when the exchange leads to a reduction in a number of connections between the two neighboring clusters, performing the exchange of the two vertices between the two neighboring clusters and repeating the two-way exchange until there are no vertices to exchange for one complete cycle. After the first stage of two-way exchange minimizes to a stable solution, the processing circuitry is configured to begin a second stage of one-way exchange including examining movement of a number of vertices from one cluster resulting from the first stage to another neighboring cluster resulting from the first stage. Each of the vertices has a weight that is a difference between the number of external edges connecting to vertices in the another neighboring cluster and the number of internal edges connecting to vertices in the one cluster, and when the movement of the number of vertices leads to a positive gain, performing the movement of the number of vertices. The gain is based on the weights of the vertices, and repeating the one-way exchange until there is no positive gain. The processing circuitry is further configured to begin a third stage comprising choosing the locations of the firewalls of the number of firewalls to isolate the clusters of the second stage from each other. The interactive display screen is further configured to output the network with indications for the chosen locations of the firewalls of the number of firewalls. Each firewall of the number of firewalls is configured to protect the plurality of wireless IoT devices, which are within a wireless communication range, from receiving malware.

In another exemplary embodiment, a method for positioning firewalls in an Internet of Things (IoT) network is described, wherein the IoT network includes a plurality of wireless IoT devices that communicate in an ad-hoc manner using direct Device-to-Device (D2D) communication links. The method includes arranging, by an interactive display screen, a graphical representation of the wireless devices based on initial relative locations. The method further includes minimizing, by processing circuitry, a number of firewalls required to divide the IoT network to a number of clusters of maximum size by performing a first stage of two-way exchange between every two neighboring clusters of the number of clusters of maximum sizes, including examining the two-way exchange of every two vertices in the two neighboring clusters, and when the exchange leads to a reduction in a number of connections between the two neighboring clusters, performing the exchange of the two vertices between the two neighboring clusters and repeating the two-way exchange until there are no vertices to exchange for one complete cycle. After the first stage of two-way exchange minimizes to a stable solution, the method includes beginning a second stage of one-way exchange including examining movement of a number of vertices from one cluster resulting from the first stage to another neighboring cluster resulting from the first stage. Each of the vertices has a weight that is a difference between the number of external edges connecting to vertices in the another neighboring cluster and the number of internal edges connecting to vertices in the one cluster, and when the movement of the number of vertices leads to a positive gain, performing the movement of the number vertices. The gain is based on the weights of the vertices, and repeating the one-way exchange until there is no positive gain. The method further includes beginning a third stage comprising choosing the locations of the firewalls of the number of firewalls to isolate the clusters of the second stage from each other, and outputting to the interactive display screen the network with indications for the chosen locations of the firewalls of the number of firewalls. Each firewall of the number of firewalls is configured to protect the plurality of wireless IoT devices, which are within a wireless communication range, from receiving malware.

In another exemplary embodiment, a non-transitory computer-readable storage medium is described, including computer executable instructions. The instructions, when executed by a computer, cause the computer to perform a method for positioning firewalls in an Internet of Things (IoT) network, wherein the IoT network includes a plurality of wireless IoT devices that communicate in an ad-hoc manner using direct Device-to-Device (D2D) communication links. The method includes arranging, by an interactive display screen, a graphical representation of the wireless devices based on initial relative locations. The method further includes minimizing, by processing circuitry, a number of firewalls required to divide the IoT network to a number of clusters of maximum size by executing a first stage of two-way exchange between every two neighboring clusters of the number of clusters of maximum sizes, including examining the two-way exchange of every two vertices in the two neighboring clusters, and when the exchange leads to a reduction in a number of connections between the two neighboring clusters, performing the exchange of the two vertices between the two neighboring clusters and repeating the two-way exchange until there are no vertices to exchange for one complete cycle. After the first stage of two-way exchange minimizes to a stable solution, the method includes beginning a second stage of one-way exchange including examining movement of a number of vertices from one cluster resulting from the first stage to another neighboring cluster resulting from the first stage. Each of the vertices has a weight that is a difference between the number of external edges connecting to vertices in the another neighboring cluster and the number of internal edges connecting to vertices in the one cluster, and when the movement of the number of vertices leads to a positive gain, performing the movement of the number vertices. The gain is based on the weights of the vertices, and repeating the one-way exchange until there is no positive gain. The method further includes beginning a third stage comprising choosing the locations of the firewalls of the number of firewalls to isolate the clusters of the second stage from each other, and outputting to the interactive display screen the network with indications for the chosen locations of the firewalls of the number of firewalls. Each firewall of the number of firewalls is configured to protect the plurality of wireless IoT devices, which are within a wireless communication range, from receiving malware.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a schematic diagram of a system for positioning firewalls in a wireless Internet of Things (IoT) network, according to certain embodiments.

FIG. 1B is a schematic illustration of a wireless IoT network topology representation as a random geometric graph (RGG), according to certain embodiments.

FIG. 2 is a schematic illustration of clustered IoT networks after applying K-means clustering with spatial firewalls and protected nodes, according to certain embodiments.

FIG. 3 is a schematic diagram of a demonstration IoT network showing initial random node distribution and device-to-device links prior to clustering, according to certain embodiments.

FIG. 4 is a schematic illustration of clustered IoT networks using the K-means algorithm with firewall placement in the “Other” firewall variation, according to certain embodiments.

FIG. 5 is a schematic illustration of clustered IoT networks following execution of a Two-Way exchange process for firewall minimization, according to certain embodiments.

FIG. 6 is a schematic illustration of clustered IoT networks following execution of a One-Way exchange process for further firewall reduction, according to certain embodiments.

FIG. 7 is a schematic illustration of clustered IoT networks using K-means clustering with the “Self” firewall protection variation, according to certain embodiments.

FIG. 8 is a schematic illustration of clustered IoT networks using Two-Way exchange optimization under the “Self” firewall protection variation, according to certain embodiments.

FIG. 9 is a schematic illustration of clustered IoT networks using One-Way exchange optimization under the “Self” firewall protection variation, according to certain embodiments.

FIG. 10 is a schematic illustration of clustered IoT networks formed using a bisection-based clustering algorithm under the “Other” firewall variation, according to certain embodiments.

FIG. 11 is a schematic illustration of clustered IoT networks formed using a bisection-based clustering algorithm under the “Self” firewall variation, according to certain embodiments.

FIG. 12 is a bar graph showing the average number of firewalls required versus maximum cluster size under the “Other” firewall variation, according to certain embodiments.

FIG. 13 is a bar graph showing the average number of firewalls required versus maximum cluster size under the “Self” firewall variation, according to certain embodiments.

FIG. 14 is a bar graph showing the average minimum of maximum cluster size for a fixed number of firewalls under the “Other” firewall variation, according to certain embodiments.

FIG. 15 is a bar graph showing the average minimum of maximum cluster size for a fixed number of firewalls under the “Self” firewall variation, according to certain embodiments.

FIG. 16 is an illustration of a non-limiting example of details of computing hardware used in the computing system, according to certain embodiments.

FIG. 17 is an exemplary schematic diagram of a data processing system used within the computing system, according to certain embodiments.

FIG. 18 is an exemplary schematic diagram of a processor used with the computing system, according to certain embodiments.

FIG. 19 is an illustration of a non-limiting example of distributed components which may share processing with the controller, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of this disclosure are directed to the containment of malware propagation in large-scale wireless Internet of Things (IoT) networks by employing dynamic and spatially-aware firewall placement strategies. Wireless IoT networks are highly vulnerable to threats of malware outbreaks due to their ad-hoc architecture, device-to-device communication protocols, and limited processing capabilities of individual nodes. To mitigate such threats, The disclosed system and method mitigate such threats from the perspective of two problems. From one perspective, the system and method solve a minimization of the number of firewalls required to isolate a network into secure isolated clusters. From another perspective, the system and method solves a maximization of the number of secure isolated clusters that can be formed with a given number of firewalls. The system incorporates heuristic algorithms based on clustering techniques and iterative exchange processes, specifically, Two-Way and One-Way exchanges, to minimize inter-cluster connections and strategically assign firewall positions/locations in an IoT network. These firewalls may either protect themselves only, or all IoT devices within their wireless communication range, with both variations being explicitly modeled and analyzed. The methods demonstrate significant performance gains over conventional clustering approaches such as K-Means, and enable scalable, cost-effective protection of IoT network infrastructure against malware epidemics.

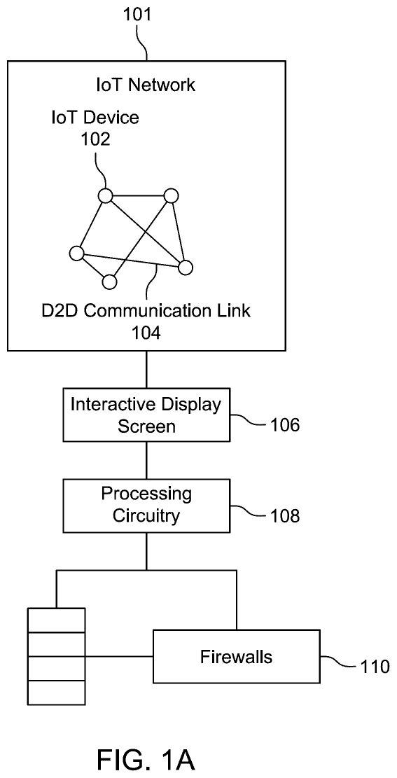

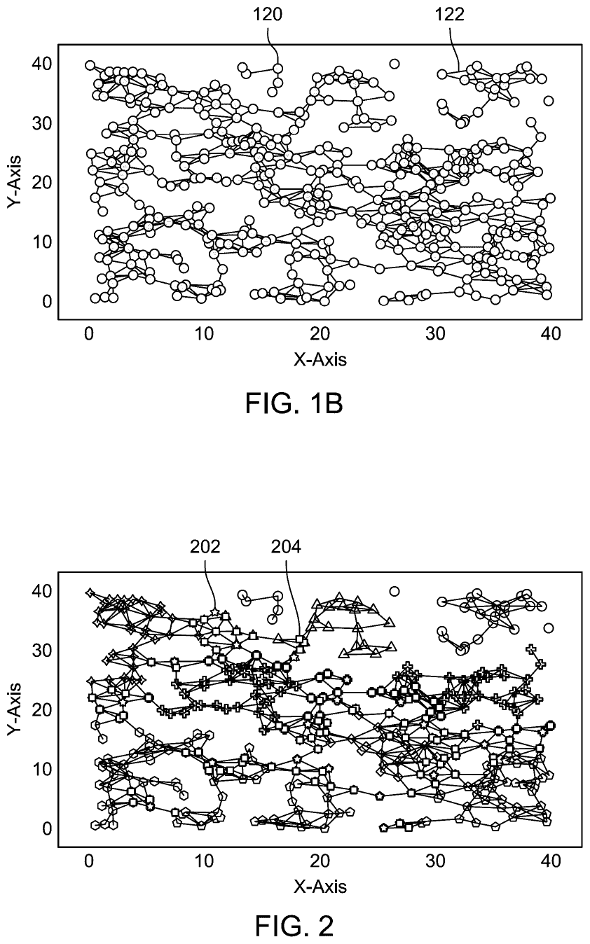

FIG. 1A illustrates a system 100 for positioning firewalls in an Internet of Things (IoT) network 101, in accordance with one embodiment. For purposes of this disclosure, the IoT network 101 includes a number of wireless IoT devices 102 that communicate in an ad-hoc manner using direct Device-to-Device (D2D) communication links 104. In some embodiments, the number of wireless IoT devices 102 is a few hundred IoT devices to several hundred IoT devices, to thousands of IoT devices. As a minimum, each IoT device includes an antenna for the D2D communication as well as processing circuitry that can become infected by malware. In an embodiment, the D2D communication by the IoT devices 102 is by omnidirectional antennas, wherein each antenna has the same communication range.

Each of the wireless IoT devices 102 may incorporate a sensing unit, which may include temperature sensors such as DS18B20 or DHT22, humidity probes such as HIH-4030, light sensors such as BH1750 or TSL2561, motion detectors such as passive infrared sensors or ultrasonic proximity sensors such as HC-SR04, gas sensors such as members of the MQ-series used for detecting gases including carbon dioxide and liquefied petroleum gas, vibration sensors that may be based on piezoelectric elements or accelerometers, or integrated environmental sensor arrays such as BME680 or SHT31 capable of capturing multiple environmental parameters. These sensing units enable the IoT devices 102 to gather real-time data from their surroundings, which may be used in various applications such as environmental monitoring, industrial automation, smart agriculture, and building management systems.

Each of the wireless IoT devices 102 may further comprise an actuation unit configured to perform physical operations in response to received signals or detected environmental stimuli. The actuation unit may include electromechanical relays such as members of the Songle SRD series used for switching high-current devices, servo motors such as the SG90 model used for position control applications, stepper motors such as NEMA17 for precise rotational control, solenoid valves for fluidic control, or lighting elements such as light-emitting diodes or smart lighting modules. These actuation components may be employed to initiate actions such as activating an alarm, opening or closing access mechanisms, modulating light intensity, or adjusting heating and cooling equipment.

The processing circuitry of each wireless IoT device 102 may be implemented as a microcontroller unit that governs sensing, processing, and communication functions. Suitable microcontrollers include members of the ARM Cortex-M family such as STM32 or NRF52, ESP32 or ESP8266 microcontrollers known for their integrated Wi-Fi and Bluetooth capabilities, or Atmega328P microcontrollers which are commonly used in resource-constrained environments. These microcontrollers are characterized by low-power operation, support for analog and digital interfacing, and native wireless communication stack integration. In some instances, the IoT devices 102 may include more capable embedded computing platforms that enable enhanced functionality and connectivity.

Such embedded platforms may include Raspberry Pi Zero W, which is a single-board computer supporting Linux-based operating systems and suitable for use as an edge computing node or gateway device; TelosB mote, a research-grade wireless sensor node compliant with the IEEE 802.15.4 standard and operable with the TinyOS operating system, often used in academic and prototyping contexts; or LoPy4 board, a development board supporting multiple communication protocols including Wi-Fi, LoRa, Sigfox, and Bluetooth Low Energy, based on the ESP32 chipset and tailored for low-power wide-area network deployments. Other suitable platforms may include Arduino MKR WAN 1310 incorporating LoRa connectivity for remote sensing applications or Particle Boron with LTE-M and Bluetooth capabilities for cellular-connected IoT deployments. These platforms may further include local data processing modules, cloud connectivity interfaces, and firmware support for secure over-the-air updates.

Each of these wireless IoT devices 102 is configured to perform low-power, short-range wireless transmission, typically operating within a communication range of 10 to 100 meters, subject to propagation conditions and the underlying wireless protocol. The devices may operate under various topologies including star, mesh, or hybrid configurations, which enhance the resilience, scalability, and reliability of the communication architecture. The energy sources for these devices may include fixed power supplies, rechargeable or disposable batteries, or energy harvesting mechanisms such as photovoltaic cells. Collectively, the sensing, actuation, processing, and communication capabilities of the wireless IoT devices 102 enable them to function autonomously and collaboratively in a distributed networked environment, thereby facilitating the real-time monitoring and control required in heterogeneous Internet of Things deployments.

The system that determines firewall placement in the IoT network can include an interactive display screen 106, configured to arrange a graphical representation of the wireless IoT devices 102 based on initial relative locations. The interactive display screen 106 can include a touchscreen graphical user interface implemented via a display monitor, tablet interface, or workstation console, and can include real-time visualization modules to render a topological graph of the IoT network 101. Each node in the visualization corresponds to one of the wireless IoT devices 102, and each edge corresponds to one of the D2D communication links 104. The interactive display screen 106 is further configured to allow drag-and-drop simulation of node relocation and may support annotations for cluster boundaries, device status, and firewall positions.

The interactive display screen 106 is operatively connected to processing circuitry 108. The processing circuitry 108 is configured to algorithms for firewall optimization and placement. The processing circuitry 108 may be implemented using a field-programmable gate array (FPGA), application-specific integrated circuit (ASIC), a multi-core CPU, or a graphics processing unit (GPU) configured for parallel processing of network partitioning algorithms. The circuitry 108 may include memory modules (e.g., DRAM, SRAM, or flash) for temporary storage of adjacency matrices, cluster assignments, and gain scores, and may implement low-level logic for rapid exchange evaluation.

One algorithm for the firewall optimization and placement minimizes a number of firewalls 110 required to divide the IoT network 101 into a number of clusters of maximum size. To accomplish this, the processing circuitry 108 is configured to perform a first stage of two-way exchange between every two neighboring clusters of the number of clusters of maximum sizes. The first stage includes examining the two-way exchange of every two vertices in the two neighboring clusters. When the exchange leads to a reduction in a number of connections between the two neighboring clusters, the processing circuitry 108 is configured to perform the exchange of the two vertices between the two neighboring clusters and repeat the two-way exchange until there are no vertices to exchange for one complete cycle. In one implementation, each vertex corresponds to an IoT device 102, and each connection corresponds to a bidirectional D2D link 104 represented in a symmetric adjacency matrix. The two-way exchange operates on a greedy principle to locally minimize the inter-cluster cut size, and may be accelerated using a Kernighan-Lin heuristic. The Kernighan-Lin (KL) heuristic is a graph partitioning algorithm designed to find a near-optimal way to divide a graph into two parts (or clusters) such that the number of edges crossing between the two parts (i.e., the cut size) is minimized. The Kernighan-Lin heuristic aims to optimize a bisection of a graph by iteratively exchanging pairs of nodes between the two partitions in a way that reduces the total number of crossing edges, thereby achieving better modularity or isolation between the two parts.

After the first stage of two-way exchange minimizes to a stable solution, the processing circuitry 108 is further configured to perform a second stage of one-way exchange, including examining movement of a number of vertices from one cluster resulting from the first stage to another neighboring cluster resulting from the first stage. Each of the vertices has a weight that is a difference between the number of external edges connecting to vertices in the another neighboring cluster and the number of internal edges connecting to vertices in the one cluster. When the movement of the number of vertices leads to a positive gain, the processing circuitry 108 is configured to perform the movement of the number of vertices. The gain is based on the weights of the vertices, and the one-way exchange is repeated until there is no positive gain. The one-way exchange stage employs a gain scoring function that computes whether the migration of each vertex improves intra-cluster cohesion while reducing external connectivity, and the iteration continues until a locally optimal cluster assignment is reached.

The processing circuitry 108 is then configured to perform a third stage comprising choosing the locations of a plurality of the firewalls 110 to isolate the clusters of the second stage from each other. The firewall position/location selection may be modeled as a vertex cover problem on the set of inter-cluster edges, such that the firewalls 110 are placed at devices that mediate the highest number of external connections. In this manner, malware propagation paths across clusters are intercepted by at least one firewall device. The interactive display screen 106 is further configured to output the network with indications for the chosen locations of the firewalls 110 of the number of firewalls. These indications may be rendered as highlighted circles, boundary color codes, or annotated device identifiers.

Each of the plurality of firewalls 110 is configured to protect the number of wireless IoT devices 102, which are within a wireless communication range, from receiving malware. Each firewall 110 is further configured to block infection of all devices that are within the wireless communication range of an initial device in the network that is subject to a malware attack. The firewalls 110 may be implemented using embedded devices with secure boot, runtime anomaly detection, and wireless quarantine capabilities. In one embodiment, firewalls 110 are physically separate units, such as OpenWrt routers, Raspberry Pi with intrusion detection system (IDS) software, while in another embodiment they are implemented as containerized security programs installed on designated IoT devices 102.

The IoT devices 102, within secured zones protected by a protecting firewall of the firewalls 110, are configured to inquire the protecting firewall 110 about software codes received from a wireless interface. The protecting firewall 110 scans the inquired software codes for security threats. When the code is legitimate and free from malware threats, the protecting firewall 110 approves it. Otherwise, the code is disapproved. For example, a firmware update broadcast from a neighboring cluster must first be verified by the firewall 110 using signature-based or behavior-based detection algorithms (e.g., ClamAV, Suricata, or custom classifiers). Upon approval, a token is issued to the requesting device 102 to proceed with code installation.

The firewalls 110 are computation devices equipped with an anti-malware program. In one implementation, the firewalls 110 are edge computing devices for a cloud layer and may participate in cloud-based coordination of security enforcement. Such firewalls 110 may run lightweight operating systems including RIOT OS, Contiki, or Ubuntu Core, and support Docker containers for deploying intrusion prevention services, including SNORT, OSSEC, or proprietary anomaly detectors. The firewalls 110 may be implemented as a limited number of software licenses to be installed on a limited number of the wireless IoT devices 102 in the network. The wireless IoT devices 102 are configured to install the firewalls 110 by downloading modules from a secure repository and executing them under constrained operating environments with watchdog monitoring.

The processing circuitry 108 is further configured to dynamically change the chosen positions/locations of the firewalls 110, where firewall software is deactivated from some of the wireless IoT devices 102 and activated on other of the wireless IoT devices 102 depending on dynamics and optimization of the firewall positions/locations. This dynamic reallocation can be triggered periodically or in response to topology changes, such as node failures, load imbalance, or mobility patterns. In one example, an IoT device 102 entering a critical region of the network can be elevated to a firewall node, while a dormant or isolated device may relinquish its firewall role.

The processing circuitry 108 is further configured to, for a given number of firewalls, maximize the number of isolated clusters that can be achieved using that number of firewalls, by repeatedly dividing a search space by two every iteration, until a minimum cluster size and a number of clusters that will give the given number of firewalls of Fmax. This binary search heuristic allows the determination of optimal clustering under limited security resources and may leverage parallel evaluation of cluster configurations over graphical processing unit (GPU) or cloud infrastructure.

In another embodiment, a method is implemented for positioning firewalls in the IoT network 101. The IoT network 101 includes wireless IoT devices 102 that communicate in an ad-hoc manner using direct Device-to-Device (D2D) communication links 104. The D2D communication by the IoT devices 102 is by omnidirectional antennas, wherein each antenna has the same communication range. The method comprises arranging, by an interactive display screen 106, a graphical representation of the wireless IoT devices 102 based on initial relative locations. Each wireless IoT device 102 is represented as a vertex in a network graph, and the D2D communication links 104 are represented as edges interconnecting the vertices.

The method further includes minimizing, by processing circuitry 108, a number of firewalls 110 required to divide the IoT network 101 to a number of clusters of maximum size. The minimizing comprises a first stage of two-way exchange between every two neighboring clusters of the number of clusters of maximum sizes. The first stage includes examining the two-way exchange of every two vertices in the two neighboring clusters. When the exchange leads to a reduction in a number of connections between the two neighboring clusters, the method includes performing the exchange of the two vertices between the two neighboring clusters and repeating the two-way exchange until there are no vertices to exchange for one complete cycle.

The method further includes, after the first stage of two-way exchange minimizes to a stable solution, beginning a second stage of one-way exchange. The second stage includes examining movement of a number of vertices from one cluster resulting from the first stage to another neighboring cluster resulting from the first stage. Each of the vertices has a weight that is a difference between the number of external edges connecting to vertices in the another neighboring cluster and the number of internal edges connecting to vertices in the one cluster. When the movement of the number of vertices leads to a positive gain, the method includes performing the movement of the number of vertices. The gain is based on the weights of the vertices, and the method includes repeating the one-way exchange until there is no positive gain.

The method further includes beginning a third stage comprising choosing the positions/locations of the firewalls 110 of the number of firewalls to isolate the clusters of the second stage from each other. The method further includes outputting, to the interactive display screen 106, the network with indications for the chosen locations of the firewalls 110 of the number of firewalls.

Each firewall 110 of the number of firewalls is configured to protect the wireless IoT devices 102, which are within a wireless communication range, from receiving malware. The method further comprises blocking, by each said firewall 110, infection of all IoT devices 102 that are within the wireless communication range of an initial IoT device in the network that is subject to a malware attack.

The method further comprises inquiring, by the IoT devices 102, within secured zones protected by a protecting firewall 110, the protecting firewall 110 about software codes received from a wireless interface. The method further includes scanning, by the protecting firewall 110, the inquired software codes for security threats. When the code is legitimate and free from malware threats, the protecting firewall 110 approves it. Otherwise, the code is disapproved. The method further comprises configuring IoT devices 102, at positions/locations of firewalls 110, with an anti-malware program. In one embodiment, the method includes installing a limited number of software licenses on a limited number of the wireless IoT devices 102 in the network. The method further comprises installing the firewalls 110 in the wireless IoT devices 102.

In another aspect, the method includes maximizing, by the processing circuitry 108, for a given number of firewalls 110, the number of isolated clusters that can be achieved using that given number of firewalls, by repeatedly dividing a search space by two every iteration, until a minimum cluster size and a number of clusters that will give the given number of firewalls of Fmax.

The method further comprises dynamically changing, by the processing circuitry 108, the chosen positions/locations of the firewalls 110, by deactivating firewall software from some of the wireless IoT devices 102 and activating firewall software on others of the wireless IoT devices 102 depending on dynamics and optimization of the firewall positions/locations. FIG. 1B illustrates an Internet of Things (IoT) wireless network topology representation, showing a spatially deployed set of nodes 120 and interconnecting edges 122. The IoT network is represented as a random geometric graph (RGG) G={V, L} of size N vertices. Each vertex in the set V corresponds to a wireless IoT device, and each edge in the set L corresponds to a bidirectional device-to-device (D2D) communication link between devices that are within communication range of each other. The X-axis corresponds to the horizontal position of an IoT device in a physical space (e.g., meters, or generic units used in simulation). The Y-axis corresponds to the vertical position of an IoT device in the same 2D space.

The spatial distribution of the nodes 120 is modelled as a Poisson Point Process (PPP) with intensity λ (devices per km²), capturing the random spatial deployment of wireless IoT devices. Each node 120 is positioned at a location xᵢ∈ [symbol] , where 1≤i≤N, and is equipped with an omnidirectional antenna having a uniform communication range r. The edges 122, representing the set of wireless D2D links, are defined by the Euclidean distance between two nodes: that is, an edge lᵢⱼ∈L exists between node xᵢ and node xⱼ if and only if |xᵢ−xⱼ|≤r, ∀i≠j.

Each node 120, corresponding to an IoT device, may be implemented using a sensor-actuator pair, a communication-enabled embedded system, or an edge-processing capable microcontroller. The degree of any node xᵢ∈V is determined by the number of neighboring devices within its communication range and is given by the cardinality |Lᵢ|, where Lᵢ={lᵢⱼ: lxᵢ−xⱼ|≤r, ∀j≠i}. The set of edges L is the union over all device-specific edges, L=Uᵢ Lᵢ. The interconnected structure formed by the nodes 120 and edges 122 facilitates ad-hoc, peer-to-peer communication among the devices in the network, forming a dense and spatially distributed mesh network.

In this network model, the infection of a single IoT device can propagate malware to all directly connected devices through edges 122, simulating a contagion-style epidemic spread. Due to the scale and interconnectivity of the IoT network, such infection can lead to a wide-area malware outbreak unless mitigation techniques are employed. FIG. 1B visually depicts the highly interconnected nature of the IoT wireless mesh using dense edge connections 122 over a randomly distributed node topology, highlighting the vulnerability to malware percolation and the necessity for structural isolation strategies using firewalls.

FIG. 2 illustrates a clustered version of the IoT wireless network of FIG. 1B after applying a clustering algorithm, specifically the K-means algorithm, for malware containment through spatial isolation. The X-axis corresponds to the horizontal position of an IoT device in a physical space (e.g., meters, or generic units used in simulation). The Y-axis corresponds to the vertical position of an IoT device in the same 2D space. As shown in FIG. 2, the nodes 120 are partitioned into distinct clusters, each denoted by a different color for visual differentiation. The edges 122 continue to represent D2D communication links between nodes located within the same communication range r.

Each cluster in FIG. 2 is surrounded by a protection boundary formed by a subset of the nodes that are designated as firewall nodes. These firewall nodes are represented by highlighted stars 202 (e.g., can be represented by green color in a colored representation) and are configured to function as spatial firewalls. The spatial firewalls 202 are selected from the set of IoT devices within the network and are dynamically activated with anti-malware functionality. Each firewall node 202 defines a secured protection zone in its wireless coverage area. Within these secured zones, a subset of nodes is protected from malware propagation and is shown as squares 204 (or can be represented by color yellow in colored representation). The protected nodes 204 are configured to inquire the associated firewall 202 about any software codes received via their wireless interface. The firewall 202 scans the received codes for malware threats, and if the code is legitimate and free of malware, it is approved; otherwise, the code is disapproved. Devices outside the protection zones operate without such inquiry functionality and are thus vulnerable to infection.

The clustering outcome shown in FIG. 2 emphasizes the importance of optimal placement of firewalls 202 to contain malware propagation. Epidemic containment is achieved by selecting firewall positions/locations that isolate clusters from one another, preventing inter-cluster malware transmission. Each firewall 202 is implemented as a software license deployed on a limited number of IoT devices. These firewall licenses can be activated or deactivated dynamically, allowing the optimization of firewall locations in real-time. Accordingly, the firewalls 202 serve to minimize the number of infected devices by creating secured and isolated partitions across the network.

The methodology illustrated in FIG. 2 corresponds to solving the two optimization problems related to firewall placement, as discussed above. The first optimization problem involves minimizing the number of firewalls 202 required to divide the network into a predefined number of isolated clusters. The second optimization problem involves maximizing the number of clusters that can be created using a fixed number of available firewall licenses. These clustering problems are computationally intractable (NP-hard), and the clustering scheme using firewalls 202 and protected nodes 204 forms the basis for heuristic algorithms described below.

In one embodiment, the first optimization problem addressed in the present disclosure pertains to minimizing the number of firewalls, denoted as |F|, required to segment a wireless Internet of Things (IoT) network into a number of clusters, each subject to a constraint on a maximum cluster size denoted as Sₘₐₓ. The set F comprises all firewall entities to be deployed within the network. The primary constraint associated with this optimization problem is that the clusters must remain perfectly isolated from one another. Specifically, for any two directly connected devices residing in different clusters, the constraint requires that at least one of the two devices must be immunized by residing within the wireless coverage range of a firewall.

Assuming that the network comprises |V| devices, the objective is to partition these devices into a set of clusters C={C₁, C₂, . . . }, and where Cluster Cᵢ is a set of vertices that can connect to each other and includes a subset of vertices that are mutually reachable, either directly or through multi-hop paths, without traversing any firewall. In practical scenarios, to enable more flexible and efficient solutions, a small tolerance margin denoted by e may be introduced, allowing each cluster to exceed the nominal maximum size Sₘₐₓ by a factor of up to (1+ϵ) provided that doing so results in a reduction in the overall number of required firewalls.

The problem formulation may be expressed mathematically as:

$${min}_{{C}_{i}} \vert F \vert \qquad ( 1 )$$

$$subject to \vert {C}_{i} \vert \leq ( 1 + ϵ ) {S}_{max} ∀ i$$

It is well-established in computational complexity theory that such clustering problems are NP-hard. Consequently, the present disclosure seeks an efficient heuristic-based solution to approximate the optimal firewall placement. The disclosed heuristic leverages the insight that the number of firewalls can be reduced by constructing the clusters such that the number of inter-cluster edges is minimized. In the ideal case where clusters are entirely isolated, i.e., there exist no interconnecting edges between devices in different clusters, no firewalls would be necessary to enforce isolation.

Once an optimized clustering structure is achieved, firewalls are selectively positioned/located at those vertices which interface with other clusters. Since multiple edges may potentially connect any two clusters, the disclosed method further refines firewall placement by prioritizing deployment at vertices that can immunize the largest number of inter-cluster connections. This strategy maximizes the efficacy of each deployed firewall and contributes to the minimization of |F|. The full details of the clustering and firewall selection algorithm are provided below.

In accordance with the first optimization problem described herein, the present disclosure further provides a detailed heuristic algorithm for minimizing the number of firewalls required to isolate clusters within a wireless IoT network, subject to a maximum cluster size constraint. The disclosed algorithm begins with the identification of naturally isolated vertices and clusters. A naturally isolated vertex is defined as a network node that has no connectivity to any other node in the graph. Such vertices, due to their intrinsic disconnection, are exempt from further consideration in the clustering process. Similarly, naturally isolated clusters refer to subsets of devices that are internally connected, have a cardinality less than or equal to the maximum permitted cluster size, and exhibit no external connectivity to other clusters. These clusters, being self-contained and compliant with isolation constraints, also do not necessitate the placement of any firewall. Hence, both isolated vertices and naturally isolated clusters are excluded from the clustering and firewall allocation process.

The detection of such clusters is efficiently achieved by evaluating each vertex's off-spring set, which comprises the vertices that can be reached from the vertex without traversing a firewall. If the size of the off-spring set falls below the maximum cluster size constraint, then the cluster formed by this vertex and its off-spring is determined to be naturally isolated. The process is repeated for subsequent vertices that do not belong to previously evaluated off-spring sets, thereby ensuring a complete assessment of the network for natural isolation. Once all naturally isolated components are excluded, the algorithm proceeds to process the remaining graph vertices. In one illustrative instance, such naturally isolated vertices and clusters may be visually represented in black color in the top region of FIG. 2, wherein two individual vertices and two small clusters exhibit no connectivity to the rest of the graph.

Upon the removal of isolated components, the algorithm proceeds to the initialization phase. Let the remaining set of vertices be denoted as V̅. The number of required clusters is then approximately estimated by dividing the cardinality of this remaining set |V̅| by the maximum cluster size Sₘₐₓ, yielding an initial number of clusters

$$\vert C \vert = \frac{\vert \overline{v} \vert}{{s}_{max}} .$$

Subsequently, the network is partitioned into |C| preliminary clusters of nearly equal size. Given that |V̅| may not be exactly divisible by |C|, this partitioning may result in slight size deviations. Various algorithms may be employed for this initial clustering step, including K-center, K-means, and K-median algorithms. In this implementation, the K-center algorithm is selected, primarily due to its reduced computational complexity when realized through a farthest-first traversal approach.

The farthest-first traversal algorithm begins by randomly selecting an initial seed vertex to serve as the core of the first cluster. Successive seed vertices are iteratively chosen to be the farthest (in graph-theoretic distance) from all previously selected seeds. Once all seed vertices are selected, the remaining vertices are assigned to the closest seed's cluster, provided the addition does not violate the cluster size constraint. After this initialization, the algorithm sequentially applies a two-way exchange process followed by a one-way exchange procedure, and finally determines optimal firewall placements as described in the following stages. The farthest-first traversal algorithm is known to exhibit a computational complexity of O(N·K), where N denotes the number of vertices and K=|C| represents the number of clusters.

The next phase involves executing the two-way exchange process. This process operates between each pair of adjacent clusters to optimize inter-cluster edge reduction. Specifically, for any two clusters that share one or more edges, the algorithm evaluates pairwise exchanges of vertices between them, ensuring the size of each cluster remains constant post-exchange. The exchange is considered beneficial and executed only if it results in a net reduction in the number of edges between the clusters-referred to as a positive gain. While basic implementations may focus only on vertices having inter-cluster edges, the present embodiment further contemplates more sophisticated exchanges involving groups of vertices. This is necessitated by scenarios wherein individual vertex exchanges do not yield improvements, but grouped exchanges do.

To facilitate these group-based assessments, each vertex within a pair of neighboring clusters is assigned a weight. This weight is calculated as the difference between the number of external edges (connecting the vertex to vertices in the neighboring cluster) and the number of internal edges (connecting the vertex to vertices within its own cluster). Formally, the weight Wi of a vertex is expressed as:

Wᵢ=Eᵢ−Iᵢ (2)
where Wᵢ, Eᵢ, Iᵢ are the weight, number of external edges, and number of internal edges of Vertex i, respectively. Notice that when calculating the weight of a vertex in one of the two considered clusters, the external edges are considered to the other cluster (not with all other clusters). The nodes of each of the two clusters are then sorted in a descending order based of their weight. Now, there are two sorted sets of vertices, denote them as Sets A and B. Next, two vertices from the two sets that will result in the highest gain if the vertices are exchanged; denote these two vertices as a₁ and b₁. The gain here is calculated as:

g₁=Wₐ_{₁}+W_{b}_{₁}−2lₐ_{₁}_{,b}_{₁}, (3)
where Wₐ_{₁}, W_{b}_{₁} are the gains of the chosen vertices in Sets A and B that will give the maximum gain, and lₐ_{₁}_{,b}_{₁}∈{0,1} is the link (edge) between these two vertices. It can be shown that, it is enough to examine the exchange between the two highest-weight vertices in each set in order to find a₁ and b₁. This can be proved by considering two possible cases; the first case is where the highest-weight points in A and B (denote them as a¹ and b¹) do not have a direct link; i.e., lₐ_{¹}_{,b}_{¹}=0, in this case the gain that will result from these two points is the highest possible gain; Wₐ_{¹}+W_{b}_{¹}, due to subtracting lₐ_{¹}_{,b}_{¹}=0 in (3), and hence a₁, b₁=a¹, b¹. On the other hand, if a¹ and b¹ have a direct link; i.e., lₐ_{¹}_{,b}_{¹}=1, then it is needed to consider the exchange with the next point in both lists a² and/or b² which might have lower weight by at least 1, but lₐ_{¹}_{,b}_{²} or lₐ_{²}_{,b}_{¹} might be zero, and hence the gain in equation (3) will be larger; e.g., Wₐ_{²}+W_{b}_{¹} or Wₐ_{¹}+W_{b}_{²}, which will be greater than Wₐ_{¹}+W_{b}_{¹}−2lₐ_{¹}_{,b}_{¹}. Going to lower vertices in the list; e.g., a³ or b³, will definitely be useless since their weight is lower than the weight of the highest-weight vertices by at least 2, while the additional gain of having lᵢⱼ=0 will not be more than 2 in (3).

Once this exchange is considered, the weights of all vertices are updated in the two clusters, and the previous steps are repeated in order to find a₂, b₂, and g₂. This process is repeated until all the vertices are exhausted. In each step, the total gain is calculated that resulted from exchanging the vertices,

$${G}_{k} = {\sum }_{i = 1}^{k} {g}_{i} \qquad ( 4 )$$

where Gₖ is the total gain in Step k. Of course, the total gain that will result from exchanging all the points of A with all the points in B must be zero. However, for k=k* that maximizes Gₖ, and then the vertices up are exchanged to Step k*. Some gains in some steps might be negative, but the gains after may balance those negative gains.

In contrast to a VLSI partitioning problem, wherein electronic components may be freely relocated without any spatial constraints, the present disclosure necessitates a more constrained approach due to the fixed relative locations of the IoT devices. Specifically, in the context of the disclosed system, the two-way exchange process is limited to only those vertices situated at the borders between neighboring clusters, namely, vertices that maintain inter-cluster connections. This selective examination of border vertices is imperative, as exchanging internal vertices that lack connections to other clusters would not contribute to a reduction in inter-cluster edges and may, in fact, increase the number of such connections, thereby undermining the objective of firewall minimization. As a result, this constrained exchange strategy not only preserves the desired cluster isolation properties but also substantially reduces the computational complexity of the algorithm in comparison to the general approach.

This targeted two-way exchange procedure is systematically applied to each pair of neighboring clusters that exhibit interconnections. Following the execution of all such border-wise exchanges, the process is iteratively repeated across all cluster pairs until a complete pass is performed with no further beneficial vertex exchanges detected. This iterative convergence behavior ensures that the clustering configuration stabilizes at a locally optimal state. Notably, prior empirical analysis has demonstrated that such a two-way exchange process typically converges within a limited number of passes, further contributing to the algorithm's computational efficiency.

Once the first stage involving the two-way exchange reaches convergence, wherein no further beneficial vertex exchanges occur across the boundaries of neighboring clusters, a second stage, termed the one-way exchange, is initiated. This stage aims to enhance the clustering configuration by examining unidirectional movement of vertices from one cluster to another without any reciprocal exchange. Unlike the initial stage which enforces size parity between clusters, the second stage leverages the tolerance allowance ε, as defined in constraint (1), which permits clusters to exceed the nominal maximum size Sₘₐₓ by a factor of (1+ε). This added flexibility enables more effective redistribution of vertices to achieve reductions in inter-cluster connectivity, and thereby, in the number of required firewalls.

To initiate the one-way exchange, a pair of neighboring clusters, denoted A and B, is considered. From each cluster, only those vertices possessing links to the opposing cluster are selected. The vertices are then ordered in descending sequence based on their weight Wᵢ=Eᵢ−lᵢ, where Ei is the number of external edges (edges connecting to vertices in the other cluster), and Ii is the number of internal edges (edges connecting to vertices within the same cluster). It is often observed that, at the outset, all weight values may be negative, implying that relocating any single vertex individually would lead to a net loss in clustering efficiency. Nevertheless, relocating a group of interconnected vertices might yield a net positive gain.

Accordingly, the gain [symbol] associated with moving the top k vertices is computed as the cumulative sum

$${{G}^{↼}}_{k} = {\sum }_{i = 1}^{k} {g}_{i} , for 1 \leq k \leq {S}^{↼} ,$$

where [symbol] represents the maximum allowable number of vertices transferable between clusters such that the resultant cluster size does not exceed the (1+ε)Sₘₐₓ maximum cluster size constraint. After evaluating all feasible values of k, the value k* that yields the maximum positive gain is selected. If [symbol] *>0, then the movement of the corresponding group of vertices is executed. Otherwise, the exchange is not performed. This one-way exchange process is repeated across all pairs of neighboring clusters, and the entire cycle is iterated until no further changes are observed in a complete pass.

The order in which vertices are considered for movement significantly impacts the effectiveness of the algorithm. While one could rely purely on descending weight order, this approach may be suboptimal if high-weight vertices are spatially dispersed. Instead, beginning with the vertex of highest weight and progressively considering its nearest neighbours fosters more cohesive cluster formation, especially when relocating a spatially contiguous group of vertices results in superior reduction of inter-cluster edges.

Regarding computational complexity, it has been established that the complexity of the two-way exchange algorithm is a function of the maximum cluster size Sₘₐₓ and the total number of clusters |C|. Specifically, the worst-case complexity for executing a two-way exchange between any two clusters, including sorting and exhaustive search over all vertex pairs, is in the order of

$${S}_{max}^{2} log ( {S}_{max} ) .$$

Accordingly, for the entire network, the total complexity is approximated as

$$𝒪 ( {\vert C \vert}^{2} {S}_{max}^{2} log ( {S}_{max} ) .$$

However, in the present disclosure, since exchanges are limited only to vertices located on the inter-cluster boundaries, the actual computational burden is considerably reduced. The one-way exchange algorithm, being less intensive than the two-way variant, is exhibits the same or lower overall complexity.

Furthermore, previous analysis also establishes that the probability of achieving a globally optimal solution through this algorithm is

$$p = {2}^{\frac{- N}{30}}$$

under the assumption of 50% edge density in the adjacency matrix, where NNN denotes the total number of vertices in the network. In contrast, the network model employed in the present system exhibits substantially lower edge densities due to limited-range D2D communication, whereby each vertex connects only to a small number of nearby neighbours. This sparsity significantly improves the likelihood of converging to a globally optimal configuration using the disclosed algorithm.

Following the two-way and one-way exchange stages, the algorithm proceeds to the firewall placement phase. At this stage, the goal is to ensure that all inter-cluster communication links are interrupted by protecting at least one vertex from each such link. A link is defined as “unprotected” if neither of the two endpoints is within the coverage range of a firewall. To minimize the total number of firewalls required, the algorithm identifies all unprotected vertices involved in inter-cluster links and ranks them in descending order according to their number of unprotected external connections, denoted as [symbol] . It is important to distinguish [symbol] , which accounts only for unprotected links, from E, which denotes all external links regardless of protection status.

The algorithm initiates firewall deployment at the vertex with the highest [symbol] value, assigning a firewall to that location. Following each assignment, all adjacent vertices covered by the new firewall are marked as protected, and the list of unprotected external links is updated accordingly. This process is repeated iteratively until all inter-cluster links have been protected by at least one firewall, thereby achieving complete cluster isolation and fulfilling the objectives of the optimization problem.

### Table 1: Algorithm 1

For a given network G, a given maximum size of clusters Sₘₐₓ and a fractional tolerance ε, Start with identifying floating verties or floating clusters that have a size less than the maximum size constraint, then apply the following steps to the remaining vertices:
1. Initialize the clustering with K-means algorithm or any other algorithm
2. Apply the two-way exchange algorithm between every two neighboring clusters in sequence. Keep repeating until no change.
3. Apply the one-way exchange algorithm between every two neighboring clusters. Keep repeating until no change.
4. Apply the firewall placement algorithm.

The algorithm described through the present embodiment is configured to solve the first problem of minimizing the number of firewalls required to divide the network into a number of clusters of maximum size, as illustrated in Table I. The algorithm is repeatable with different initialization.

In accordance with a second optimization objective, this section addresses the problem of maximizing the number of isolated clusters that can be constructed within a wireless IoT network given a fixed number of deployable firewalls. Analogous to the first optimization problem discussed previously, this formulation imposes a constraint on the maximum permissible size of each cluster. Specifically, for a network comprising |V| devices, if the total number of resulting clusters is denoted as |C|, then the cluster size of each cluster must be constrained to a maximum size of

$$\vert {C}_{i} \vert \leq ( 1 + ϵ ) \frac{\vert V \vert}{\vert C \vert} .$$

This constraint ensures that all clusters are approximately of equal size, thereby minimizing the potential impact of malware propagation, particularly in scenarios involving epidemic outbreaks across densely connected devices.

The formal mathematical formulation of the problem is expressed as:

$${max}_{{F}_{i} , {C}_{i}} \vert C \vert \qquad ( 5 )$$

$$subject to \vert F \vert \leq {F}_{max} \qquad ( 5 )$$

$$\vert {C}_{i} \vert \leq ( 1 + ϵ ) \frac{\vert V \vert}{\vert C \vert} ∀ i \qquad ( 5 )$$

This problem is inherently more complex than the previous problem, since neither the total number of clusters |C|, nor the precise composition of vertices within each cluster, is known a priori. Nevertheless, the methodology to address this problem builds directly upon the algorithmic solution to the first optimization problem described in a subsequent section. The subsequent section describes the proposed extension of the prior algorithm to resolve this new problem instance.

To solve this second problem efficiently, a bisection-based approach is employed. In the algorithm, the number of firewalls required to partition the network into clusters was minimized under a constraint on maximum cluster size. However, it is evident that decreasing the maximum cluster size Sₘₐₓ leads to an increase in the total number of clusters |C|, and simultaneously results in a higher number of required firewalls. Conversely, increasing Sₘₐₓ results in fewer clusters and typically requires fewer firewalls. Leveraging this inverse relationship, the bisection algorithm is an outer optimization loop wrapped around the clustering algorithm, in order to determine the smallest value of Sₘₐₓ (and thus the largest feasible value of |C|) that satisfies a fixed budget of firewalls Fₘₐₓ.

### Table 2

As illustrated in the pseudo-code of Table 2, for a given number of firewalls Fₘₐₓ, it is assumed that the solution to the maximum number of clusters is between a lower bound of 2 clusters and an upper bound of M clusters, where M can be chosen arbitrarily large so that the number of required firewalls F≥Fₘₐₓ.
1. Start with letting nₗ=2 and nₕ=M,
2. Let

$${n}_{m e d} = Floor \{ \frac{{n}_{l} + {n}_{h}}{2} \} ,$$

3. If n_{med}=nₗ, then Stop.
4. Apply Algorithm 1 to the case of |C|=n_{med}, and Calculate the number of required firewalls F_{med},
5. If F_{med}≤Fₘₐₓ, then let nₗ=n_{med} and go to Step 2,
   Else if F_{med}>Fₘₐₓ, then let nₕ=n_{med} and go to Step 2

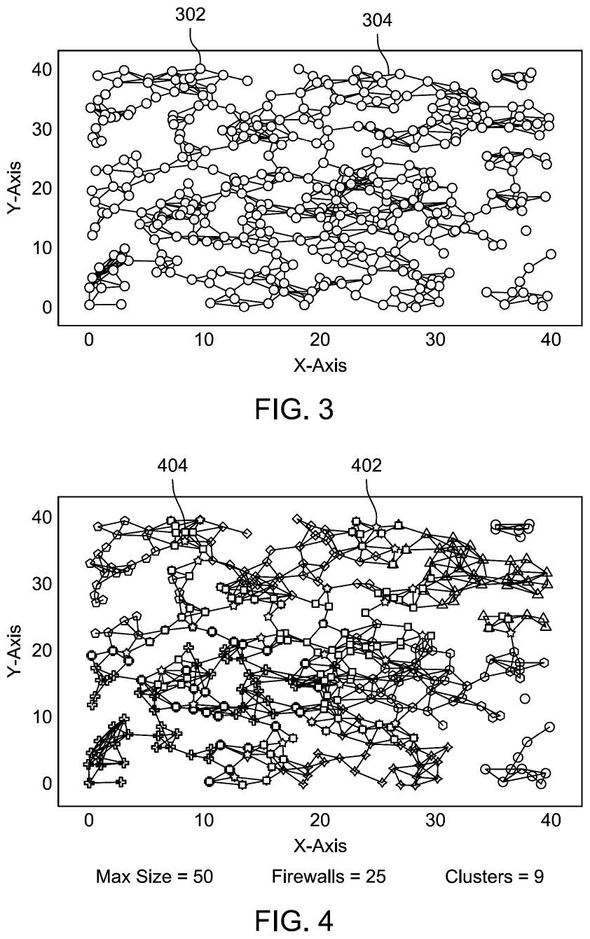

In order to validate the efficacy of the disclosed algorithms for firewall placement in a wireless IoT network, numerical evaluations can be conducted and compared against the baseline performance of the well-established K-Means clustering algorithm. Two variations of the disclosed algorithms can be considered in the analysis. In the first variation, referred to as the “Other” variation, each firewall is assumed to be capable of protecting all IoT devices within its wireless communication range. In the second variation, referred to as the “Self” variation, each firewall is configured to protect only the node on which it is deployed, without extending protection to surrounding devices. The numerical evaluation is discussed in conjunction with FIG. 3 to FIG. 9.

FIG. 3 illustrates a demonstration (demo) network comprising 400 wireless IoT devices randomly distributed over an area of 40×40 square units, with each device having a wireless communication range r=3 units. The X-axis corresponds to the horizontal position of an IoT device in a physical space (e.g., meters, or other distance measurements). The Y-axis corresponds to the vertical position of an IoT device in the same 2D space. In the first case study, Algorithm 1 was applied to the demo network. The objective was to partition the network into clusters of maximum size 50, with a tolerance of 10 percent. An initial network configuration is presented in FIG. 3.

The wireless IoT devices are represented as nodes 302 in a two-dimensional spatial domain, and the device-to-device (D2D) communication connectivity between neighbouring IoT devices is represented as edges 304. Each edge 304 is established if the Euclidean distance between any two nodes 302 is less than or equal to the communication range r, thereby forming a random geometric graph (RGG). In this demo, the spatial deployment of the nodes 302 follows a Poisson Point Process (PPP) with an intensity λ, representing the average number of IoT devices per unit area. The graph illustrated in FIG. 3 models the baseline interconnectivity of the IoT network prior to any clustering or firewall placement and represents the full set of unclustered and unsecured D2D links across the wireless mesh. The Euclidean proximity-based formation of the links results in a dynamic and randomly structured topology, which is susceptible to malware propagation due to the absence of any partitioning or secured zones. This network serves as the base test scenario for subsequent firewall clustering strategies.

FIG. 4 illustrates a result of the application of the K-Means clustering algorithm on the demo network of FIG. 3, in which the 400 wireless IoT devices are clustered into 9 clusters, each of a maximum cluster size of 50, using 25 firewalls. The X-axis corresponds to the horizontal position of an IoT device in a physical space. The Y-axis corresponds to the vertical position of an IoT device in the same 2D space.

The firewalls are represented by stars 402, and the wireless IoT devices that are within the communication range of a respective firewall are represented by squares 404, signifying protected nodes. In an embodiment, each cluster can be depicted in a distinct color, indicating the spatially segmented portions of the network after the K-Means clustering operation. In this implementation, firewalls 402 serve to isolate clusters by forming protective boundaries that mitigate malware propagation between clusters. The spatial positioning of the firewalls 402 is determined such that the coverage range fully encloses critical edge boundaries between clusters, providing intra-cluster immunity through secured zones. The figure demonstrates that the K-Means algorithm requires 25 firewalls to satisfy the constraint of maximum cluster size of 50 devices with a tolerance ε=10%. The clustering outcome represented in FIG. 4 highlights the spatial limitations of conventional clustering algorithms, providing a performance baseline for comparative analysis with the two-way and one-way exchange clustering algorithms shown in subsequent figures. The figure visually indicates that although K-Means is effective in creating segmented groups, it does not minimize the number of required firewalls efficiently, and further optimizations may lead to significant firewall reductions as discussed in the following figures.

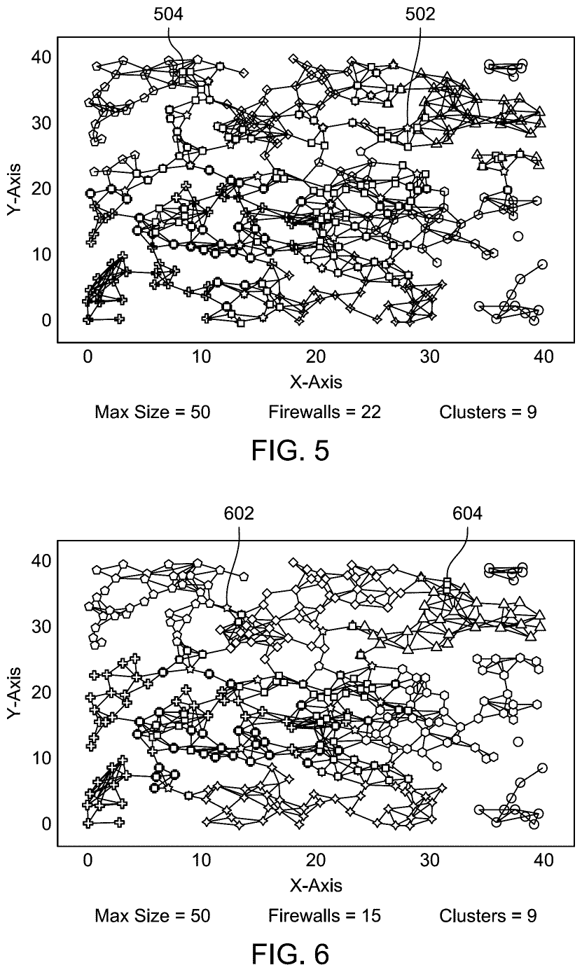

FIG. 5 illustrates a result of the application of the disclosed clustering algorithm on the same demonstration network as shown in FIG. 3, following execution of a Two-Way exchange process. The X-axis corresponds to the horizontal position of an IoT device in a physical space. The Y-axis corresponds to the vertical position of an IoT device in the same 2D space. In this example, a total of 400 wireless IoT devices are deployed over an area of 40×40 square units. Each wireless IoT device is configured with a uniform communication range of 3 units. The Two-Way exchange algorithm aims to reduce the number of firewalls while maintaining the maximum cluster size constraint of 50 devices per cluster. As shown in FIG. 5, the wireless IoT devices are partitioned into 9 distinct clusters based on the application of the Two-Way exchange stage. The number of required firewalls has been reduced to 22 firewalls, compared to 25 firewalls required when the K-Means clustering algorithm was applied as shown in FIG. 4.

The network visualization in FIG. 5 includes a number of wireless IoT devices graphically represented as Nodes 502, where each node can be visualized with a unique cluster-specific color to indicate its cluster affiliation. Direct device-to-device (D2D) communication links between neighbouring devices within communication range are illustrated as black Edges. Firewalls 502 are represented by star-shaped markers and indicate selected nodes that have been configured to host spatial firewall software. Protected Nodes 504, which are within the wireless coverage range of the firewalls 502 and hence are secured from malware propagation, are denoted by square-shaped markers. The boundaries of the clusters are implicitly delineated based on connectivity and D2D edge cuts. It is evident that the clustering and firewall placement resulting from the Two-Way exchange method achieves a lower firewall count while still meeting the isolation and protection constraints for cluster segmentation and malware containment. The Two-Way exchange leads to improved clustering efficiency by iteratively exchanging vertices between neighbouring clusters, such that inter-cluster D2D edge connections are minimized while ensuring cluster size constraints are not violated.

FIG. 6 illustrates the output of the One-Way exchange process of the disclosed clustering algorithm. The X-axis corresponds to the horizontal position of an IoT device in a physical space. The Y-axis corresponds to the vertical position of an IoT device in the same 2D space. The clustering algorithm is implemented following the Two-Way exchange process of FIG. 5 to further optimize the number of required firewalls. As with previous figures, the demo network consists of 400 wireless IoT devices distributed over a 40×40 unit region, with each device having a communication range of 3 units. The network is segmented into 9 clusters, constrained by a maximum allowable cluster size of 50 wireless devices. The One-Way exchange stage considers the gain metric of each vertex, calculated as the difference between the number of external edges connecting the vertex to another cluster and the number of internal edges connecting the vertex to its current cluster. Vertices whose movement results in positive gain are reassigned to new clusters to minimize inter-cluster connectivity. As a result of the One-Way exchange, the total number of firewalls required is reduced further to 15, achieving a 40% reduction compared to the baseline K-Means clustering approach shown in FIG. 4.

In FIG. 6, the wireless IoT devices are represented as Nodes 602, which can be shown in various colors to distinguish their cluster memberships. The communication links, or Edges, between the devices are shown in black and represent D2D connectivity for devices within communication range. The spatial firewalls 602 are shown as star symbols and are strategically positioned at boundary nodes of the clusters to ensure isolation from malware spread. The Protected Nodes 604, located within the coverage radius of the spatial firewalls 602, are represented using square markers. These protected nodes form secured zones that are scanned and approved by the corresponding firewalls prior to code execution. Devices outside these secured zones are vulnerable to malware propagation. As seen in FIG. 6, the application of the One-Way exchange method yields a significant improvement in firewall optimization and effective isolation between clusters. The heuristic nature of the clustering ensures scalable implementation while maintaining resilience against malware spread in large-scale wireless IoT networks.

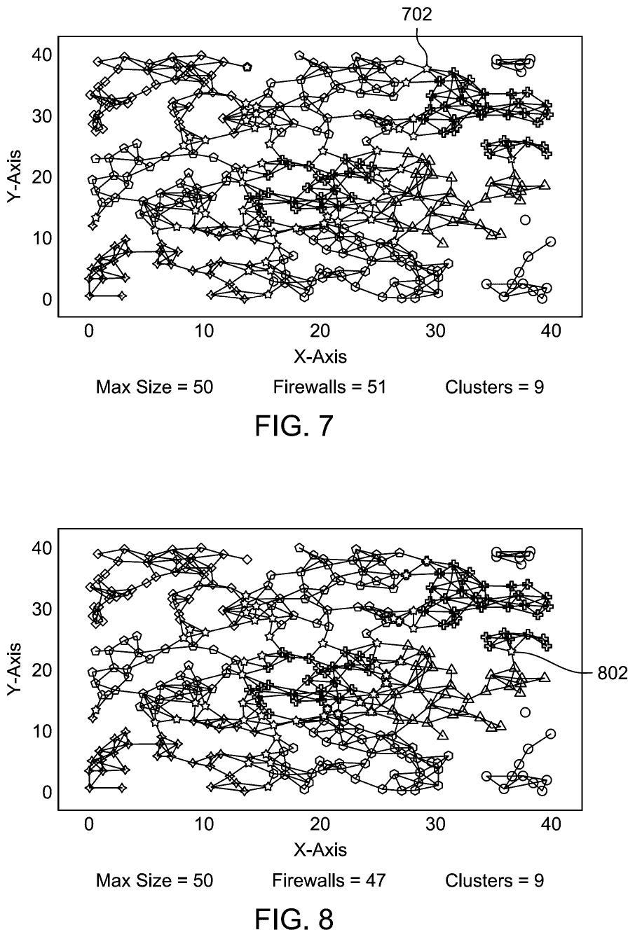

FIG. 7 illustrates a clustered wireless IoT network generated by applying a K-Means clustering algorithm under the “Self” variation of firewall protection. The X-axis corresponds to the horizontal position of an IoT device in a physical space. The Y-axis corresponds to the vertical position of an IoT device in the same 2D space. The network includes a set of wireless IoT devices (nodes), which are distributed in a two-dimensional area of 40×40 square units with a fixed communication range of 3 units. In the “Self” variation, each firewall 702 is configured to protect only the device on which it is installed, and not any surrounding devices. As a result, the protection coverage is limited to a single node, necessitating a larger number of firewalls to achieve inter-cluster isolation. The firewalls 702 are depicted as star symbols distributed across the clustered network. Nine clusters are formed, with a maximum cluster size of 50 devices, as shown in the legend. In this configuration, 51 firewalls are required to maintain cluster isolation.

The application of the K-Means clustering algorithm in the “Self” firewall protection variation highlights the challenge of achieving optimal firewall allocation due to the limited protective scope of each firewall. The substantial number of firewalls underscores the reduced efficiency of static clustering techniques when applied to the self-contained firewall protection model.

FIG. 8 illustrates the same clustered network of wireless IoT devices under the “Self” firewall protection variation, following the application of a Two-Way exchange optimization algorithm. The X-axis corresponds to the horizontal position of an IoT device in a physical space. The Y-axis corresponds to the vertical position of an IoT device in the same 2D space. As in FIG. 7, the communication range is limited to 3 units, and the clustering objective is to isolate the network into nine clusters with a maximum size of 50 devices. In this Two-Way exchange method, every two neighbouring clusters are iteratively analysed for vertex exchanges that minimize inter-cluster connections. When a vertex exchange between two neighbouring clusters results in a reduction in the number of connections between the clusters, the exchange is executed, and the process is repeated until no more beneficial exchanges are found in a complete iteration. As a result of the Two-Way optimization, the number of required firewalls 802 (shown as stars) is reduced to 47, while still maintaining full isolation of the nine clusters. Compared to the 51 firewalls required in FIG. 7 using K-Means clustering, this represents a measurable improvement in efficiency, despite the constraints of the “Self” firewall protection model. The enhanced clustering achieved through the Two-Way exchange demonstrates the benefit of iterative optimization over static clustering for firewall placement in limited-scope protection scenarios.

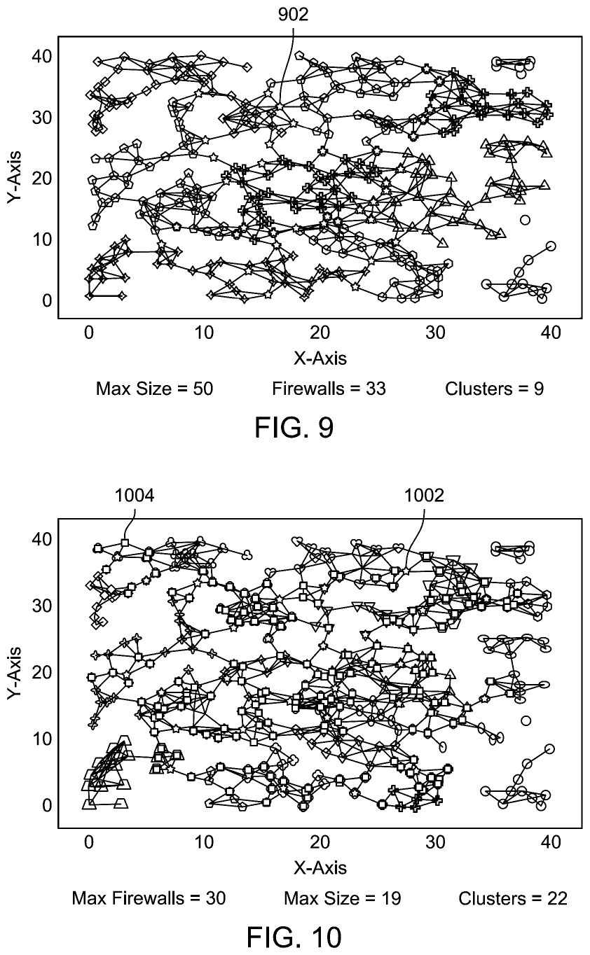

FIG. 9 illustrates the clustered IoT network under the “Self” variation of firewall protection, following the application of a One-Way exchange algorithm. The X-axis corresponds to the horizontal position of an IoT device in a physical space. The Y-axis corresponds to the vertical position of an IoT device in the same 2D space. The network conditions remain consistent with previous figures, namely, a spatial distribution of wireless IoT devices across a 40×40 unit area with a communication range of 3 units, and a clustering objective of nine clusters with a maximum size of 50 devices. In this One-Way exchange optimization, the processing circuitry examines vertices in one cluster for potential movement to a neighbouring cluster when such a movement results in a positive gain. The gain is calculated based on the difference between the number of external edges connecting to the destination cluster and the number of internal edges connecting to the originating cluster. When the gain is positive, the movement is performed, and the process continues until no further gainful movements are possible. Following this optimization, the number of required firewalls 902 (shown as stars) is significantly reduced to 33. This represents a substantial improvement over both the K-Means result (FIG. 7, 51 firewalls) and the Two-Way exchange result (FIG. 8, 47 firewalls). The optimization achieved through the One-Way algorithm illustrates a 35% reduction in firewall requirements compared to the K-Means baseline, demonstrating the strength of gain-based dynamic optimization strategies in scenarios where firewalls are limited to self-protection. The results underscore the relevance of adaptive firewall positioning in large-scale IoT networks and support the effectiveness of the disclosed heuristic optimization approach.

FIG. 10 illustrates a demo network bisection using Algorithm 2, assuming the “Other” variation of firewalls, wherein the firewalls 1002 are configured to immunize all wireless IoT devices within their wireless communication range. The demo network shown in FIG. 10 corresponds to the same network forming interconnected nodes in a spatial plane of 40×40 square units, having a D2D communication range of 3 units. The X-axis corresponds to the horizontal position of an IoT device in a physical space. The Y-axis corresponds to the vertical position of an IoT device in the same 2D space. The IoT devices are connected to each other via wireless D2D communication links forming clusters that are visually represented in different colours. The wireless IoT devices represented as nodes are protected based on spatially optimized firewall deployment using a bisection-based clustering algorithm. The firewalls 1002 are graphically denoted by stars, while protected nodes 1004, i.e., the IoT devices falling within the secured communication range of the corresponding firewall, are depicted as squares. The goal of Algorithm 2 is to maximize the number of isolated clusters subject to a given number of available firewalls by performing a bisection search over the cluster size. In this embodiment, the number of firewalls is restricted to a maximum of 30, and the bisection algorithm identifies that the minimum cluster size required to isolate the IoT network into the maximum possible number of clusters is 19. Accordingly, a total of 22 clusters are formed using 30 firewalls, with each cluster not exceeding the size of 19 nodes. The firewalls 1002 form secured zones around themselves, protecting each of the protected nodes 1004 within their coverage. These protected nodes 1004 are prevented from executing or relaying any software code without prior approval from the firewall 1002. Software codes received via a wireless interface by any protected node 1004 are inquired to the firewall 1002, which scans the code for malware. If the code is determined to be legitimate and threat-free, it is approved for execution; otherwise, the code is disapproved. The output visualization in FIG. 10 confirms the efficacy of Algorithm 2 in partitioning the network to achieve epidemic containment through optimized firewall positioning and maximum cluster isolation, with protected zones enveloping critical communication nodes.

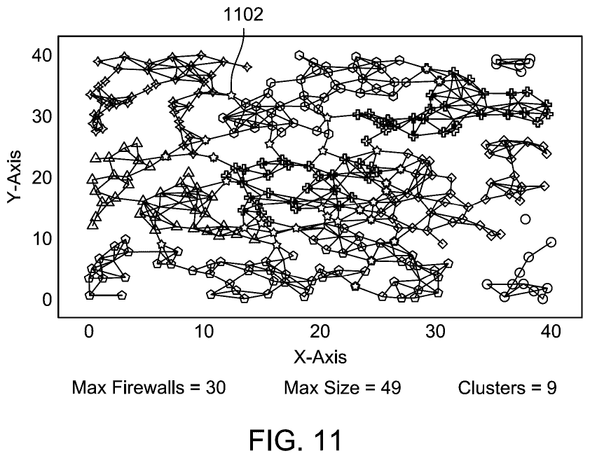

FIG. 11 illustrates the application of Algorithm 2 on the same demo network, now assuming the “Self” variation of the firewall configuration. The X-axis corresponds to the horizontal position of an IoT device in a physical space. The Y-axis corresponds to the vertical position of an IoT device in the same 2D space. In this configuration, the firewalls 1102 are limited to protecting and immunizing only the specific device on which the firewall is installed, and do not form secured zones around other neighbouring devices. Each firewall 1102 is shown as a star (can be represented by color in color representation), without any protected nodes extending beyond their installation device. The visualization indicates the resulting trade-off in protection coverage and firewall count under the “Self” variation. With the maximum number of available firewalls fixed at 30, the same network configuration results in only 9 clusters, and the maximum cluster size increases significantly to 49, due to the restricted protective range of each firewall 1102. As each firewall 1102 protects only the host device, epidemic containment becomes more difficult, and therefore fewer clusters can be safely isolated using the same number of firewalls. The underlying reason is the lack of shared secured zones among neighbouring IoT devices, which limits the firewall's ability to block malware propagation across the network. The IoT devices can be displayed in various colors representing different clusters, and the edges between them represent the direct D2D communication links. The experiment demonstrates the reduced effectiveness of the “Self” variation in minimizing maximum cluster size compared to the “Other” variation when executing Algorithm 2 under equivalent firewall constraints. FIG. 11 thereby provides a visual confirmation of the algorithmic performance trade-off between firewall variation strategies for epidemic containment in wireless IoT networks.

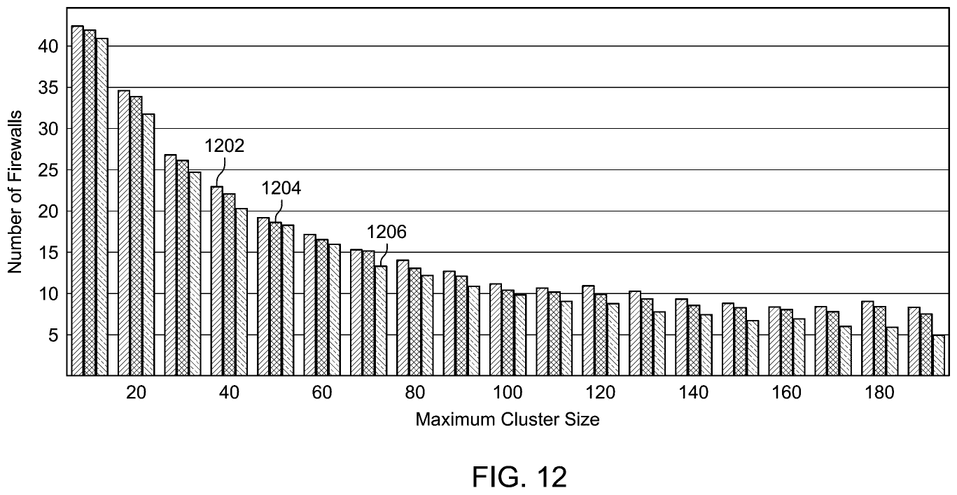

FIG. 12 illustrates a bar graph depicting the average number of firewalls required versus the maximum cluster size in a network of 400 nodes in a spatial area of 40×40 square units, wherein the communication range r of each node is 3 units. The analysis is conducted under the “Other” variation of firewalls, wherein each firewall immunizes all other devices within its wireless communication range. The x-axis of the graph denotes the maximum cluster size, and the y-axis denotes the number of firewalls. Three algorithmic approaches are compared: K-means clustering 1202, Two-Way exchange algorithm 1204, and One-Way exchange algorithm 1206. It is noted that the results of the One-Way exchange algorithm are based on use of results of using the Two-Way exchange algorithm. The data clearly illustrates that for each fixed maximum cluster size, the One-Way exchange algorithm 1206 consistently requires the fewest number of firewalls, followed by the Two-Way exchange algorithm 1204, with K-means clustering 1202 requiring the highest number of firewalls. This demonstrates the superiority of the disclosed algorithms in minimizing firewall deployment requirements across a range of maximum cluster sizes (from 10 to 200).

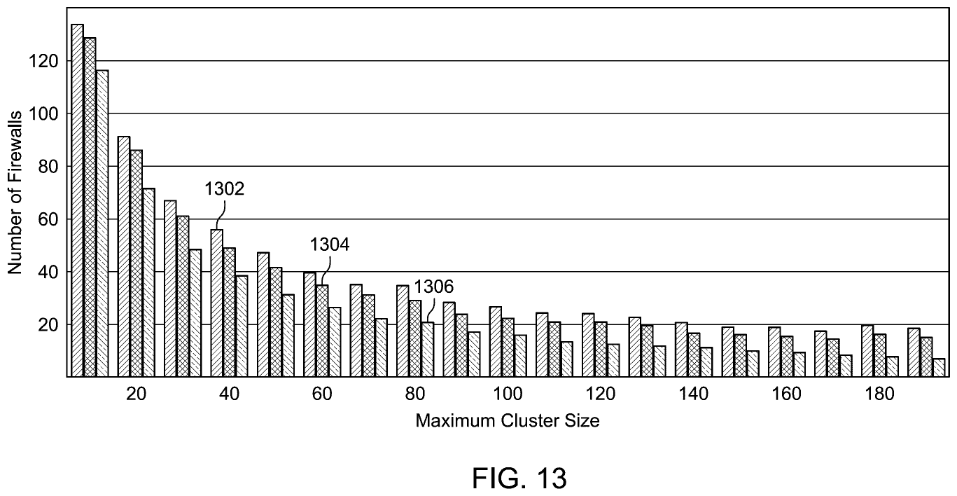

FIG. 13 illustrates a bar graph showing the average number of firewalls required versus the maximum cluster size in a network of 400 nodes distributed within a 40×40 square unit area, each having a communication range r of 3 units, under the “Self” variation of firewalls. In this variation, each firewall protects only itself and does not provide coverage to neighbouring devices. The x-axis represents the maximum cluster size, while the y-axis represents the number of firewalls. The comparison is made among K-means clustering 1302, Two-Way exchange algorithm 1304, and One-Way exchange algorithm 1306. The graph reveals that across all maximum cluster sizes, the number of firewalls required in the “Self” variation is significantly higher compared to the “Other” variation as shown in FIG. 12. However, similar to the trend observed in the “Other” variation, the One-Way exchange algorithm 1306 remains the most efficient in minimizing firewall usage, followed by the Two-Way exchange algorithm 1304 and K-means clustering 1302.

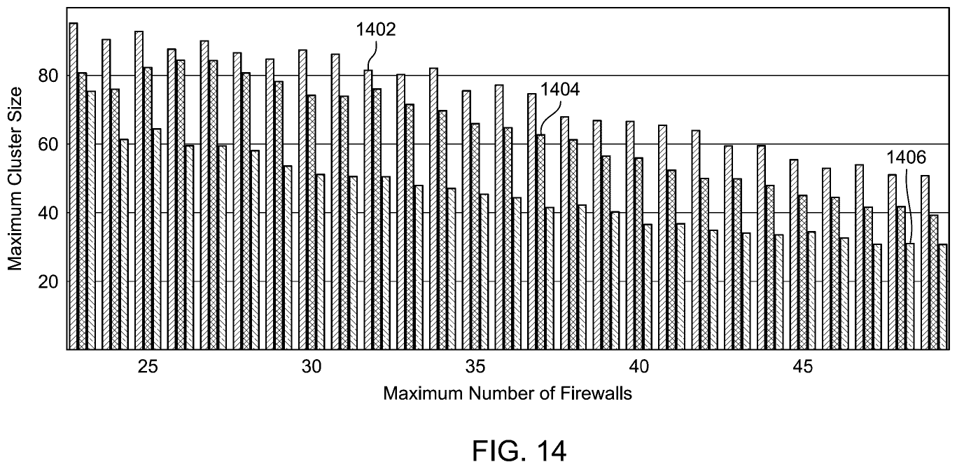

FIG. 14 illustrates the average minimum of the maximum cluster size that can be obtained using a given number of firewalls, evaluated over 100 different random networks, each consisting of 400 nodes randomly distributed within a 40×40 square unit area with a communication range r of 3 units. This analysis is based on the “Other” variation of firewalls, wherein each firewall protects all neighbouring devices in its communication range. The x-axis denotes the maximum number of available firewalls, while the y-axis denotes the average maximum cluster size that can be achieved. The performance of three different algorithms is depicted: K-means clustering 1402, Two-Way exchange algorithm 1404, and One-Way exchange algorithm 1406. The graph demonstrates that, on average, the One-Way exchange algorithm 1406 produces the smallest maximum cluster sizes, thus enabling a larger number of isolated clusters. The Two-Way exchange algorithm 1404 also outperforms the K-means approach 1402 across the range of firewall quantities. These results highlight the superior containment and isolation properties of the disclosed clustering strategies.

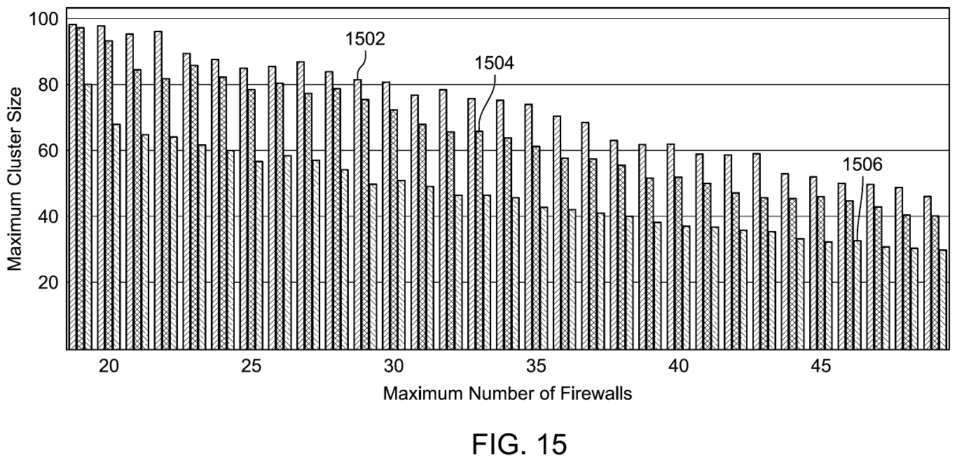

FIG. 15 illustrates a bar graph comparing the average minimum of the maximum cluster size that can be obtained using a given number of firewalls across 100 different networks, each containing 400 nodes distributed in a 40×40 square unit area with communication range r set to 3 units, under the “Self” variation of firewalls. In this variation, a firewall only protects itself, not surrounding devices. The x-axis represents the maximum number of firewalls available, and the y-axis indicates the maximum cluster size that results from the clustering process. As shown, K-means clustering 1502 results in the largest average cluster sizes, followed by the Two-Way exchange algorithm 1504, while the One-Way exchange algorithm 1506 consistently yields the smallest cluster sizes for any given firewall count. Compared to FIG. 14, the “Self” variation necessitates larger cluster sizes to accommodate the same number of firewalls, reaffirming the reduced protection efficacy of individual-only firewalling. These insights further substantiate the benefits of the One-Way and Two-Way algorithms in minimizing potential epidemic spread within constrained firewall budgets.

The algorithms introduced herein are heuristic in nature, and their operational strategy is fundamentally rooted in the reduction of inter-cluster edges as a means to minimize the total number of required firewalls. However, it must be noted that the correlation between edge reduction and firewall minimization is not strictly linear. For instance, there may exist scenarios wherein two clusters are initially connected by five edges requiring only a single firewall for isolation. If the number of interconnecting edges is reduced to one through the algorithmic process, it may still necessitate the deployment of a single firewall. Thus, such reduction does not always yield a tangible decrease in the firewall count, potentially limiting the algorithm's effectiveness in certain topologies.

To enhance the practical performance of the implementation, it is essential to incorporate conditional logic to circumvent situations that may inadvertently increase the number of required firewalls. Such conditions may include, but are not limited to, avoiding the relocation of a node to a cluster with which it shares no edges, and prioritizing the movement of nodes that lack internal connections to their current cluster, even if the numerical gain associated with such movement is marginally lower than that of other candidates. These refinements, while highly technical, are purposefully deferred to the discussion section so as not to disrupt the logical continuity of the algorithmic exposition provided earlier in the specification.

Moreover, it is important to recognize that the results obtained for any single network instance are inherently dependent on the initial clustering configuration. Consequently, the algorithm may converge to a local minimum that does not reflect the global optimum. It is therefore advisable to execute the disclosed algorithm multiple times with varying initial clustering arrangements. This approach allows the identification of several locally optimal solutions, among which the best-performing configuration may be selected-thereby increasing the likelihood of achieving a global minimum.

Additionally, the intuitive assumption that increasing the maximum allowable cluster size will necessarily result in a reduced number of firewalls does not always hold. This is due to the fact that enlarging cluster sizes may alter the inter-cluster boundaries in such a way that existing clusters are inadvertently divided, requiring additional firewall deployments to maintain isolation. Such non-monotonic behaviour is empirically evident in the results presented in FIGS. 12 and 13, particularly when comparing configurations with maximum cluster sizes of 160 and 180, where a counterintuitive increase in firewall count is observed.

In conclusion, the present disclosure addresses two fundamental optimization problems in the domain of secure wireless IoT networking. The first problem focuses on minimizing the number of firewalls required to segment a network into clusters of bounded maximum size. The second problem considers the complementary objective of minimizing the maximum cluster size that can be achieved for a fixed budget of available firewalls. To address these challenges, two heuristic algorithms have been disclosed. Algorithm 1, grounded in the strategic reduction of inter-cluster connectivity, is used to solve the first optimization problem. Algorithm 2 employs a bisection method, layered upon Algorithm 1, to determine the optimal cluster size corresponding to a fixed firewall count. Simulation results confirm that the disclosed algorithms consistently outperform conventional clustering strategies, including the widely used K-Means algorithm. Nonetheless, further improvements can be achieved through targeted enhancements that address edge-case behaviours and incorporate refined conditional logic within the implementation framework.

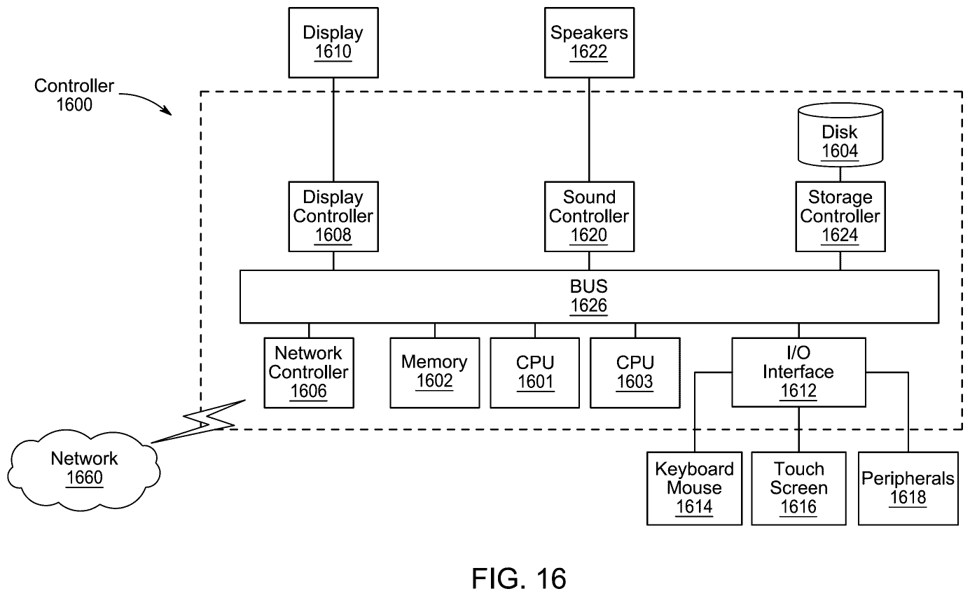

Next, further details of the hardware description of a computing environment according to exemplary embodiments is described with reference to FIG. 16. In FIG. 16, a controller 1600 is described is representative of the system 100 of FIG. 1A in which the controller is a computing device which includes a CPU 1601 which performs the processes described above. The process data and instructions may be stored in memory 1602. These processes and instructions may also be stored on a storage medium disk 1604 such as a hard drive (HDD) or portable storage medium or may be stored remotely.

Further, the disclosure is not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the disclosure may be provided as a utility application, background daemon, or component of an operating system, or combination thereof, executing in conjunction with CPU 1601, 1603 and an operating system such as Microsoft Windows 7, Microsoft Windows 10, Microsoft Windows 11,UNIX, Solaris, LINUX, Apple MAC-OS and other systems known to those skilled in the art.

The hardware elements in order to achieve the computing device may be realized by various circuitry elements, known to those skilled in the art. For example, CPU 1601 or CPU 1603 may be a Xenon or Core processor from Intel of America or an Opteron processor from AMD of America, or may be other processor types that would be recognized by one of ordinary skill in the art. Alternatively, the CPU 1601, 1603 may be implemented on an FPGA, ASIC, PLD or using discrete logic circuits, as one of ordinary skill in the art would recognize. Further, CPU 1601, 1603 may be implemented as multiple processors cooperatively working in parallel to perform the instructions of the inventive processes described above.

The computing device in FIG. 16 also includes a network controller 1606, such as an Intel Ethernet PRO network interface card from Intel Corporation of America, for interfacing with network 1660. As can be appreciated, the network 1660 can be a public network, such as the Internet, or a private network such as an LAN or WAN network, or any combination thereof and can also include PSTN or ISDN sub-networks. The network 1660 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The computing device further includes a display controller 1608, such as a NVIDIA GeForce GTX or Quadro graphics adaptor from NVIDIA Corporation of America for interfacing with display 1610, such as a Hewlett Packard HPL2445w LCD monitor. A general purpose I/O interface 1612 interfaces with a keyboard and/or mouse 1614 as well as a touch screen panel 1616 on or separate from display 1610. General purpose I/O interface also connects to a variety of peripherals 1618 including printers and scanners, such as an OfficeJet or DeskJet from Hewlett Packard.

A sound controller 1620 is also provided in the computing device such as Sound Blaster X-Fi Titanium from Creative, to interface with speakers/microphone 1622 thereby providing sounds and/or music.

The general purpose storage controller 1624 connects the storage medium disk 1604 with communication bus 1626, which may be an ISA, EISA, VESA, PCI, or similar, for interconnecting all of the components of the computing device. A description of the general features and functionality of the display 1610, keyboard and/or mouse 1614, as well as the display controller 1608, storage controller 1624, network controller 1606, sound controller 1620, and general purpose I/O interface 1612 is omitted herein for brevity as these features are known.

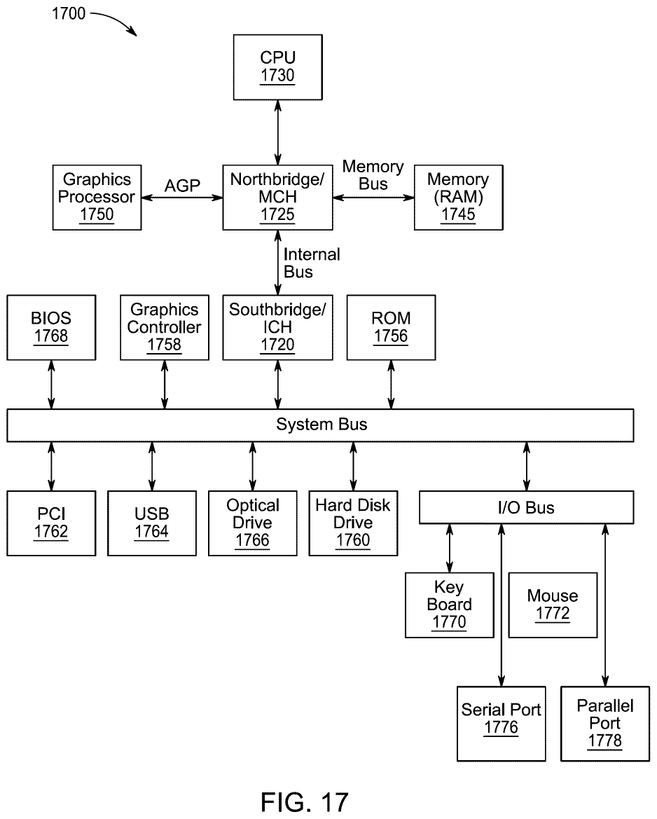

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 17.

FIG. 17 shows a schematic diagram of a data processing system, according to certain embodiments, for performing the functions of the exemplary embodiments. The data processing system is an example of a computer in which code or instructions implementing the processes of the illustrative embodiments may be located.

In FIG. 17, data processing system 1700 employs a hub architecture including a north bridge and memory controller hub (NB/MCH) 1725 and a south bridge and input/output (I/O) controller hub (SB/ICH) 1720. The central processing unit (CPU) 1730 is connected to NB/MCH 1725. The NB/MCH 1725 also connects to the memory 1745 via a memory bus, and connects to the graphics processor 1750 via an accelerated graphics port (AGP). The NB/MCH 1725 also connects to the SB/ICH 1720 via an internal bus (e.g., a unified media interface or a direct media interface). The CPU Processing unit 1730 may contain one or more processors and even may be implemented using one or more heterogeneous processor systems.

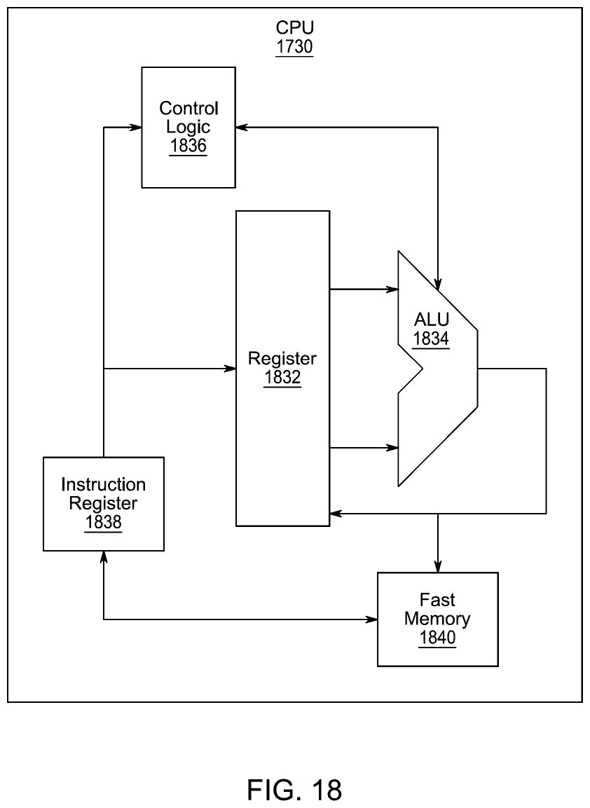

For example, FIG. 18 shows one implementation of CPU 1730. In one implementation, the instruction register 1838 retrieves instructions from the fast memory 1840. At least part of these instructions are fetched from the instruction register 1838 by the control logic 1836 and interpreted according to the instruction set architecture of the CPU 1730. Part of the instructions can also be directed to the register 1832. In one implementation the instructions are decoded according to a hardwired method, and in another implementation the instructions are decoded according to a microprogram that translates instructions into sets of CPU configuration signals that are applied sequentially over multiple clock pulses. After fetching and decoding the instructions, the instructions are executed using the arithmetic logic unit (ALU) 1834 that loads values from the register 1832 and performs logical and mathematical operations on the loaded values according to the instructions. The results from these operations can be feedback into the register and/or stored in the fast memory 1840. According to certain implementations, the instruction set architecture of the CPU 1730 can use a reduced instruction set architecture, a complex instruction set architecture, a vector processor architecture, a very large instruction word architecture. Furthermore, the CPU 1730 can be based on the Von Neuman model or the Harvard model. The CPU 1730 can be a digital signal processor, an FPGA, an ASIC, a PLA, a PLD, or a CPLD. Further, the CPU 1730 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 17, the data processing system 1700 can include that the SB/ICH 1720 is coupled through a system bus to an I/O Bus, a read only memory (ROM) 1756, universal serial bus (USB) port 1764, a flash binary input/output system (BIOS) 1768, and a graphics controller 1758. PCI/PCIe devices can also be coupled to SB/ICH 1788 through a PCI bus 1762.

The PCI devices may include, for example, Ethernet adapters, add-in cards, and PC cards for notebook computers. The Hard disk drive 1760 and CD-ROM 1766 can use, for example, an integrated drive electronics (IDE) or serial advanced technology attachment (SATA) interface. In one implementation the I/O bus can include a super I/O (SIO) device.

Further, the hard disk drive (HDD) 1860 and optical drive 1766 can also be coupled to the SB/ICH 1720 through a system bus. In one implementation, a keyboard 1770, a mouse 1772, a parallel port 1778, and a serial port 1776 can be connected to the system bus through the I/O bus. Other peripherals and devices that can be connected to the SB/ICH 1720 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry or based on the requirements of the intended back-up load to be powered.

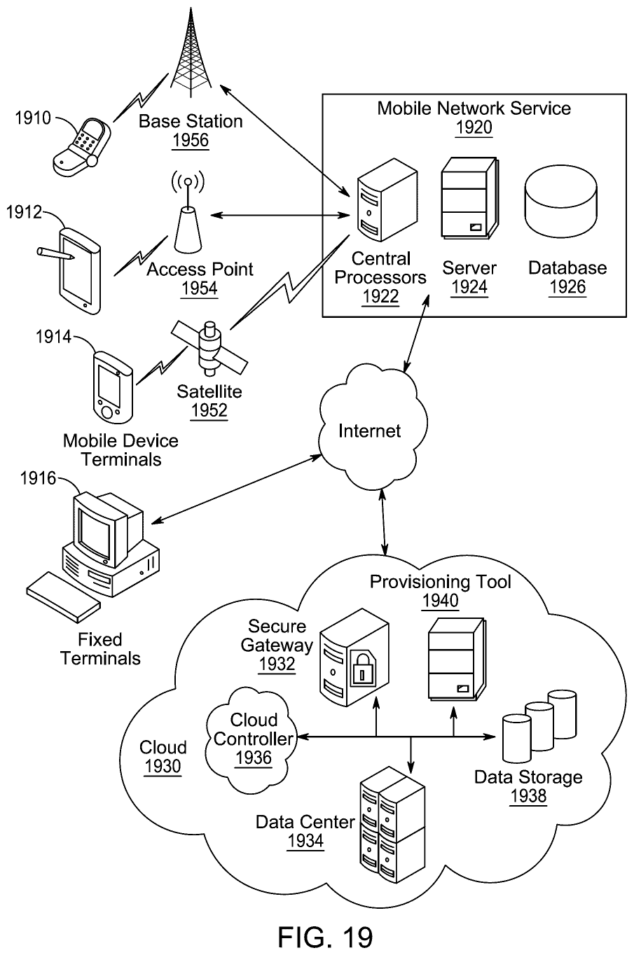

The functions and features described herein may also be executed by various distributed components of a system. For example, one or more processors may execute these system functions, wherein the processors are distributed across multiple components communicating in a network. The distributed components may include one or more client and server machines, such as cloud 1930 including a cloud controller 1936, a secure gateway 1932, a data center 1934, data storage 1938 and a provisioning tool 1940, and mobile network services 1920 including central processors 1922, a server 1924 and a database 1926, which may share processing, as shown by FIG. 19, in addition to various human interface and communication devices (e.g., display monitors 1916, smart phones 1910, tablets 1912, personal digital assistants (PDAs) 1914). The network may be a private network, such as a LAN, satellite 1952 or WAN 1954, or be a public network, may such as the Internet. Input to the system may be received via direct user input and received remotely either in real-time or as a batch process. Additionally, some implementations may be performed on modules or hardware not identical to those described. Accordingly, other implementations are within the scope that may be claimed.

The above-described hardware description is a non-limiting example of corresponding structure for performing the functionality described herein.

Numerous modifications and variations of the present disclosure are possible in light of the above teachings. It is therefore to be understood that within the scope of the appended claims, the invention may be practiced otherwise than as specifically described herein.

1. A system for positioning firewalls in an Internet of Things (IoT) network, wherein the IoT network includes a plurality of wireless IoT devices that communicate in an ad-hoc manner using direct Device-to-Device (D2D) communication links, the system comprising:
an interactive display screen, configured to arrange a graphical representation of the wireless devices based on initial relative locations;
processing circuitry configured to minimize a number of firewalls required to divide the IoT network to a number of clusters of maximum size, by
a first stage of two-way exchange between every two neighboring clusters of the number of clusters of maximum sizes, including examining the two-way exchange of every two vertices in the two neighboring clusters, and when the exchange leads to a reduction in a number of connections between the two neighboring clusters, perform the exchange of the two vertices between the two neighboring clusters, and repeat the two-way exchange until there are no vertices to exchange for one complete cycle; and
after the first stage of two-way exchange minimizes to a stable solution, begin a second stage of one-way exchange including examining movement of a number of vertices from one cluster resulting from the first stage to another neighboring cluster resulting from the first stage, wherein each of the vertices has a weight that is a difference between the number of external edges connecting to vertices in the another neighboring cluster and the number of internal edges connecting to vertices in the one cluster, and when the movement of the number of vertices leads to a positive gain, perform the movement of the number vertices, wherein the gain is based on the weights of the vertices, and repeat the one-way exchange until there is no positive gain;
begin a third stage comprising choosing the locations of the firewalls of the number of firewalls to isolate the clusters of the second stage from each other; and
wherein the interactive display screen is further configured to output the network with indications for the chosen locations of the firewalls of the number of firewalls,
wherein each firewall of the number of firewalls is configured to protect the plurality of wireless IoT devices, which are within a wireless communication range, from receiving malware.

2. The system of claim 1, wherein the processing circuitry is further configured to, for a given number of firewalls, maximize the number of isolated clusters that can be achieved using that number of firewalls, by
repeatedly dividing a search space by two every iteration, until a minimum cluster size and a number of clusters that will give the given number of firewalls of Fmax.

3. The system of claim 1, wherein the D2D communication by the IoT devices is by omnidirectional antennas, wherein each antenna has the same communication range.

4. The system of claim 1, wherein each said firewall is configured to block infection of all devices that are within the wireless communication range of an initial device in the network that is subject to a malware attack.

5. The system of claim 1, wherein the IoT devices, within secured zones protected by a protecting firewall, are configured to inquire the protecting firewall about software codes received from a wireless interface,
wherein the protecting firewall scans the inquired software codes for security threats,
wherein when the code is legitimate and free from malware threats, the protecting firewall approves it, otherwise, the code is disapproved.

6. The system of claim 1, wherein the firewalls are computation devices equipped with an anti-malware program.

7. The system of claim 1, wherein the firewalls are edge computing devices for a cloud layer.

8. The system of claim 2, wherein the given number of firewalls are a limited number of software licenses to be activated on a limited number of the plurality of wireless IoT devices in the network.

9. The system of claim 1, wherein the plurality of wireless IoT devices are configured to install the firewalls.

10. The system of claim 1, wherein the processing circuitry is further configured to dynamically change the chosen locations of the firewalls, where firewall software is deactivated from some of the plurality of wireless IoT devices and activated on other of the plurality of wireless IoT devices depending on dynamics of the wireless IoT devices and optimization of the firewall locations.

11. A method for positioning firewalls in an Internet of Things (IoT) network, wherein the IoT network includes a plurality of wireless IoT devices that communicate in an ad-hoc manner using direct Device-to-Device (D2D) communication links, the method comprising:
arranging, by an interactive display screen, a graphical representation of the wireless devices based on initial relative locations;
minimizing, by processing circuitry, a number of firewalls required to divide the IoT network to a number of clusters of maximum size, by
a first stage of two-way exchange between every two neighboring clusters of the number of clusters of maximum sizes, including examining the two-way exchange of every two vertices in the two neighboring clusters, and when the exchange leads to a reduction in a number of connections between the two neighboring clusters, perform the exchange of the two vertices between the two neighboring clusters, and repeat the two-way exchange until there are no vertices to exchange for one complete cycle; and
after the first stage of two-way exchange minimizes to a stable solution, begin a second stage of one-way exchange including examining movement of a number of vertices from one cluster resulting from the first stage to another neighboring cluster resulting from the first stage, wherein each of the vertices has a weight that is a difference between the number of external edges connecting to vertices in the another neighboring cluster and the number of internal edges connecting to vertices in the one cluster, and when the movement of the number of vertices leads to a positive gain, perform the movement of the number vertices, wherein the gain is based on the weights of the vertices, and repeat the one-way exchange until there is no positive gain;
begin a third stage comprising choosing the locations of the firewalls of the number of firewalls to isolate the clusters of the second stage from each other; and
outputting to the interactive display screen the network with indications for the chosen locations of the firewalls of the number of firewalls,
wherein each firewall of the number of firewalls is configured to protect the plurality of wireless IoT devices, which are within a wireless communication range, from receiving malware.

12. The method of claim 11, further comprising, maximizing, by the processing circuitry, for a given number of firewalls, the number of isolated clusters that can be achieved using that given number of firewalls, by
repeatedly dividing a search space by two every iterations, until a minimum cluster size and a number of clusters that will give the given number of firewalls of Fmax.

13. The method of claim 11, further comprising directly communicating between IoT devices by the D2D communication links by omnidirectional antennas, wherein each antenna has the same communication range.

14. The method of claim 11, further comprising blocking, by each said firewall, infection of all IoT devices that are within the wireless communication range of an initial IoT device in the network that is subject to a malware attack.

15. The method of claim 11, further comprising
inquiring, by the IoT devices, within secured zones protected by a protecting firewall, the protecting firewall about software codes received from a wireless interface;
scanning, by the protecting firewall, the inquired software codes for security threats,
approving, by the protecting firewall, the software code when the code is legitimate and free from malware threats, otherwise, disapproving the software code.

16. The method of claim 11, further comprising configuring IoT devices, at locations of firewalls, with an anti-malware program.

17. The method of claim 12, further comprising activating a limited number of software licenses on a limited number of the plurality of wireless IoT devices in the network.

18. The method of claim 11, further comprising installing the firewalls in the plurality of wireless IoT devices.

19. The method of claim 11, further comprising, dynamically changing, by the processing circuitry, the chosen locations of the firewalls, by deactivating firewall software from some of the plurality of wireless IoT devices and activating firewall software on other of the plurality of wireless IoT devices depending on dynamics of the wireless IoT devices and optimization of the firewall locations.

20. A non-transitory computer-readable storage medium including computer executable instructions, wherein the instructions, when executed by a computer, cause the computer to perform a method for positioning firewalls in an Internet of Things (IoT) network, wherein the IoT network includes a plurality of wireless IoT devices that communicate in an ad-hoc manner using direct Device-to-Device (D2D) communication links, the method comprising:
arranging, by an interactive display screen, a graphical representation of the wireless devices based on initial relative locations;
minimizing, by processing circuitry, a number of firewalls required to divide the IoT network to a number of clusters of maximum size, by
a first stage of two-way exchange between every two neighboring clusters of the number of clusters of maximum sizes, including examining the two-way exchange of every two vertices in the two neighboring clusters, and when the exchange leads to a reduction in a number of connections between the two neighboring clusters, perform the exchange of the two vertices between the two neighboring clusters, and repeat the two-way exchange until there are no vertices to exchange for one complete cycle; and
after the first stage of two-way exchange minimizes to a stable solution, begin a second stage of one-way exchange including examining movement of a number of vertices from one cluster resulting from the first stage to another neighboring cluster resulting from the first stage, wherein each of the vertices has a weight that is a difference between the number of external edges connecting to vertices in the another neighboring cluster and the number of internal edges connecting to vertices in the one cluster, and when the movement of the number of vertices leads to a positive gain, perform the movement of the number vertices, wherein the gain is based on the weights of the vertices, and repeat the one-way exchange until there is no positive gain;
begin a third stage comprising choosing the locations of the firewalls of the number of firewalls to isolate the clusters of the second stage from each other; and
outputting to the interactive display screen the network with indications for the chosen locations of the firewalls of the number of firewalls,
wherein each firewall of the number of firewalls is configured to protect the plurality of wireless IoT devices, which are within a wireless communication range, from receiving malware.
